(19) United States
(12) Patent Application Publication
(10) Pub. No.: US 2002/0029208 A1
(43) Pub. Date: Mar. 7, 2002

(54) Data gathering and distribution apparatus and methods

(76) Inventor: Daryl Craig Josephson, Burlingame, CA (US)

Correspondence Address: Henneman & Saunders, 121 E. 11th Street, Tracy, CA, 95376, US

(21) Appl. No.: 09/948,293

(22) Filed: Sep. 6, 2001

Related U.S. Application Data
(60) Provisional application No. 60/230,325, filed on Sep. 6, 2000.

(51) Int. Cl. G06F 17/30

(52) U.S. Cl. 707/1; 707/10; 707/3

(57) ABSTRACT

A novel data gathering method includes determining criteria for transferring a selected data portion from a source to at least one destination, interfacing with the source, gathering the selected data portion and other data according to the criteria, and distributing the data and the other data to at least one destination according to said criteria. Optionally, the gathered data is manipulated and/or augmented according to the gather criteria. Such processing of the data may occur before, during, and/or after the gathering and/or distribution of the data. A system for implementing the novel method is also disclosed.

### CROSS-REFERENCE TO RELATED APPLICATIONS

The present application hereby claims priority to U.S. Provisional Application No. 60/230,325, by Daryl C. Josephson, filed on Sep. 6, 2000, and entitled “Data Gathering and Distributing Apparatus and Methods.” Application No. 60/230,325 is hereby fully incorporated herein by reference.

### BACKGROUND

1. Field of the Invention

The present invention relates generally to data processing systems, and more particularly, to tools invokable via a data processing system to select, transfer and/or manipulate computer readable information. Description of Background Art Despite their evolution, conventional data processing systems continue to proliferate the limitations and inefficiencies of long-standing foundational precepts. So-called cut, copy and paste tools, for example, moved from specialized functions to global toolsets that now permeate most computer programs. They now include the abilities to transfer locally or remotely stored multimedia data types, to paste active links or formulae as viewable data, and to utilize a multiple-buffer clipboard and graphical controls. Nevertheless, these and other “global” data manipulation tools continue to proliferate traditional generic datablock manipulation.

Generic datablock manipulation, as used herein, broadly refers to manipulating a selected chunk-of-data or “datablock” without regard to its relevance or that of included data. For example, a user of cut-copy-paste tools explicitly selects one or more files, folders or document objects (i.e. a datablock). Next, he explicitly selects a generic tool to move or copy the datablock into a buffer, explicitly selects a destination, and then explicitly selects a generic “paste” tool to deposit the buffered datablock at the destination. A search tool user similarly explicitly enters a search criteria and invokes a search tool that responds by generically returning matching datablocks or datablock links. Still other tools also operate on an explicitly user-selected datablock in a similarly generic manner.

Unfortunately, using such tools is often laborious and distracting. Using cut-copy-paste tools to transfer a single datablock, for example, requires finding the datablock and selecting “cut” or “copy,” finding a destination and selecting it, and then selecting “paste”. Even greater user control is required where a datablock is transferred between a largely-separated source and destination (e.g. within different document pages, documents, subfolders, etc.). Multiple transfers can further exacerbate such difficulties, as can multiple searches or other such generic operations.

Generic datablock manipulation also might not produce desired results. For example, given even a single source of disparately placed desirable datablocks, transferring one datablock will fail to provide other desirable data, while transferring an inclusive datablock also transfers data that separates the desirable data. A transferred datablock also often contains data that is undesirably located and arranged, and no intrinsic documentation mechanism yet exists. Generically manipulated datablocks further often require additional datablock tool selection, data entry, datablock transfers, formatting and/or other additional manipulations.

Among further disadvantages of particularly generic datablock transfers are incompatibilities and security concerns. For example, generic datablock transfers often produce unpredictable results—particularly where a datablock is transferred between two different machines, operating systems or program types. Generic datablock transfers also often either wholly avoid or are rendered wholly inoperable by conventional security, and no intrinsic mechanisms for tracking datablock accesses or transfers yet exist.

Accordingly, there is a need for apparatus and methods that enable globally operable data transfers and other processing, while reducing user demands and providing more desirable results. There is further a need for such apparatus and methods that enable incompatibilities that hinder such capabilities to be avoided. There is still further a need for such apparatus and methods that enable improved security and data access and transfer tracking.

### SUMMARY

Apparatus and methods according to embodiments of the invention enable the advantages of generic datablock handling, while further enabling user demand reduction, documentation and datablock portion processing that are implementable as or in conjunction with globally applicable tools. Such apparatus and methods further provide for data organization, formatting, transactions, documenting and/or other operabilities, and are capable of resolving incompatibilities and providing improved security and data access and transfer tracking.

Embodiments of the invention provide for gathering, processing and distributing data portions that can include data contained within datablocks (i.e. program code and/or data) as well as extra-datablock data. Embodiments provide for determining appropriate selection and processing of multimedia data portions. Such determining can also be made according to source/destination program type, layout, context, content, user selection, defaults, artificial intelligence and/or other mechanisms. Embodiments further provide for negotiating security/tracking protocols with data sources and/or destinations. Embodiments provide for locating data by monitoring intermittently available data, identifying user-indicated data, index consulting, parsing and/or other mechanisms, and for gathering and pre-processing portions of such data. Intermediate processing and distributing portions of such processed and/or unprocessed data portions is also provided. Embodiments further provide for post-processing distributed data, including, for example, formatting, re-arranging and/or forming links among disparately located data portions.

Accordingly, a suitable data gathering system comprises a criteria engine for determining criteria according to which data is to be manipulated; a data selection engine for enabling user determinable data selection; a data-gatherer for determining intermittently available and statically available not discretely selected data; a negotiating engine for negotiating security, data tracking, e-commerce and other source/destination interfacing; a data portion processor for performing pre-transfer, intermediate and/or post distribution data portion processing; and a data distributor for depositing available (e.g. gathered) data portions at one or more destination locations.

A data gathering method according to an embodiment of the invention comprises determining criteria according to which a selected data portion is to be transferred from a source; conducting applicable interface, security and/or tracking protocols with the source; gathering the data portion and other data portions indicated by the criteria (if any); distributing the selected data portion and other data portions to one or more determinable data-destinations; and performing additional processing corresponding with the gathering, distribution and/or processing (if any).

Another gathering method according to an embodiment of the invention comprises determining operational parameters; and, in accordance with the operational parameters, gathering subject-data and supplemental-data from at least one source, performing applicable data manipulations to form resultant data, determining at least one destination for the resultant data, and depositing the resultant data within the at least one destination.

Among other benefits, data gathering enables dynamic use-oriented significance to be established among data transfers, data, sources, destinations and/or other factors. Thus, for example, a researcher can focus on conducting research while intermittently selecting references that are automatically notated, formatted and distributed within one or more spreadsheets, cells/fields, summary reports, email, web pages, etc. An attorney can “gather” properly cited case excerpts from an automatically negotiated provider to a brief, link and/or citation list, with similarly automatic Shepardizing. A patent attorney can gather amendments to produce an “as amended” application, linkable claims, claim summary, graphics, etc. One or more information portions can further be gathered according to the amendment portion, other contexts/sub-contexts, gather criteria selection, etc. Existing information (e.g. a transcript, medical record, etc.) can also be automatically parsed for appropriate data portions and tracking/billing can be automatically generated, among other examples. Embodiments further enable such “gathering,” conventional or enhanced cut-copy-paste, and/or other capabilities to be conducted in a similar globally applicable manner that is also useful in a wide variety of other applications.

These and other objects, advantages and benefits of the present invention will become apparent from the drawings and specification that follow. The objects, advantages and benefits disclosed herein are not intended to be an exhaustive list. Moreover, it will be possible to practice the invention even where one or more of the intended objects and/or advantages might be absent or not required in a particular application. Further, those skilled in the art will recognize that various embodiments of the present invention may achieve one or more, but not necessarily all of the above described objects, advantages, and/or benefits. Accordingly, the included objects, advantages and/or benefits should not be construed as essential limitations.

### BRIEF DESCRIPTION OF THE DRAWINGS

The present invention is described with reference to the following drawings, wherein like reference numbers denote substantially similar elements:

FIG. 1 is a diagrammatic representation of the operation of a data gathering system according to an embodiment of the present invention;

FIG. 2 is a diagrammatic representation of the sequential operation of a data gathering system according to an embodiment of the present invention;

FIG. 3 is a diagrammatic representation of the handling of multi-media files by a data gathering system according to an embodiment of the present invention;

FIG. 4 is a diagrammatic representation of the distribution of gathered data into a spreadsheet by a data gathering system according to an embodiment of the present invention;

FIG. 5 is a diagrammatic representation of the distribution of gathered data into a word processing document by a data gathering system according to an embodiment of the present invention;

FIG. 6 is a diagrammatic representation of the distribution of gathered data to a destination according to a particular context/subcontext by a data gathering system according to an embodiment of the present invention;

FIG. 6A is a diagrammatic representation of the distribution of gathered data to a summary form and a status form, according to an embodiment of the invention;

FIG. 7 is a diagrammatic representation of a data gathering system according to an embodiment of the present invention being incorporated in an exemplary system;

FIG. 8 is a diagrammatic representation of gathered data being distributed to a destination, being re-gathered from that destination, and being distributed to another destination, all by a data gathering system according to an embodiment of the present invention;

FIG. 9 is block diagram showing a general purpose system capable of hosting a data gathering system according to an embodiment of the present invention;

FIG. 10 is a block diagram of the working memory of the system of FIG. 9;

FIG. 11 is a block diagram detailing the gather engine of FIG. 10;

FIG. 12 is a diagrammatic representation of exemplary alternate implementations of a gather system in conjunction with a search engine;

FIG. 13 shows a variety of exemplary user interface schemes appropriate for use with certain embodiments of the gather system of the present invention;

FIG. 14 is a flow chart illustrating a data gathering method according to an embodiment of the present invention;

FIG. 15 is a flow chart illustrating an alternate example data gathering method according to an embodiment of the present invention;

FIG. 16 is a flow chart illustrating a method of determining gather parameters according to an embodiment of the invention;

FIG. 17 is a flow chart illustrating a method of gathering data from one or more sources corresponding to determined gather parameters, according to an embodiment of the invention;

FIG. 18 is a flow chart illustrating a method of manipulating and/or augmenting gathered data and information (collectively “gathered data”) in accordance with determined gather parameters, according to an embodiment of the invention;

FIG. 19 is a flow chart illustrating a method of distributing gathered and resultant data to one or more destinations in accordance with determined gather parameters, according to an embodiment of the invention;

FIG. 20 is a flow chart illustrating a method of detemining gather parameters according to a context, destination and/or prior transfer, according to an embodiment of the invention; and

FIG. 21 is a flow chart illustrating a method of determining gather parameters using a priority scheme, according to an embodiment of the invention.

### DETAILED DESCRIPTION

The present invention overcomes the problems associated with the prior art, by providing flexible data gathering systems and methods. Certain gathering system and method embodiments are, for example, capable of responding to the selection of a single data portion by gathering associated data from one or more data sources, manipulating gathered data, and distributing the resultant manipulated data or portions thereof to one or more destinations. In the following description, numerous specific details are set forth (e.g., exemplary application program types, gathering functions, system layouts, etc.) in order to provide a thorough understanding of the invention. Those skilled in the art will recognize, however, that aspects of the invention may be practiced apart from these specific details. In other instances, details of suitable well known software engineering practices (e.g., particular structures, programming languages, multitasking, etc.) and components have been omitted, so as not to unnecessarily obscure particular aspects/embodiments of the present invention.

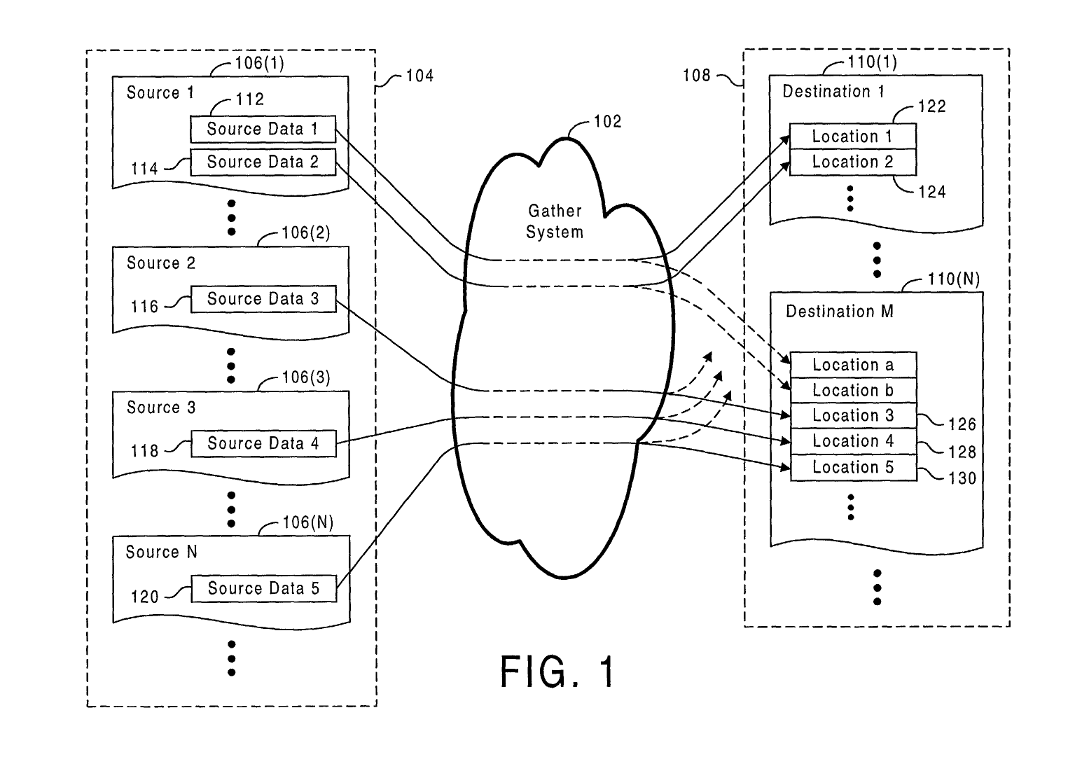

FIG. 1 shows a diagrammatic representation of the operation of a data gathering system according to an embodiment of the present invention. Gather system 102 gathers data from a plurality 104 of data sources 106(1−N), and distributes the gathered data to a plurality 108 of destinations 110(1−M), all responsive to the selection of a single data portion 112, and according to a set of predetermined parameters (gather criteria). For example, responsive to a user selecting data portion 112, gather system 102 automatically gathers data portions 112, 114, 116, 118, and 120. Data portions 112 and 114 are then distributed to locations 122 and 124 of destination 110(1), respectively. Data portions 116, 118, and 120 are similarly distributed to locations 126, 128, and 130, respectively, of destination 110(M) as part of the overall “gathering” (i.e. including any gather, processing, distribution and/or other gather system operations).

The dashed arrows in FIG. 1 show how any particular data portion can be distributed (or not) to any of the destinations, depending on the applicable gather criteria (not shown). In other words, each of destinations 110(1−M) may receive a “portion” (i.e. all or only a contiguous or non-contiguous subset), of the gathered data and/or “information”. Note that, where necessary for clarification, a program code or data portion not selected by a gather system (e.g. selected by a user or other system) will be referred to as “data”, while a program code or data portion selected by a gather system will be referred to as “information”, “other data” or “additional data”, each irrespective of whether the data and/or information might be gathered, executed, or otherwise processed by the gather system. “Gathered data” will further refer collectively to data, information, other data, additional data or any portion or combination thereof.

Plurality 104 of data sources 106(1−N) can include sources that are internal, external, local, and/or remote (at least intermittently wired or wirelessly coupleable) with respect to gather system 102 and/or with respect to one another. Examples of potential data sources 106(1−N) include, but are not limited to internal or external hard/optical drives, local area network (LAN) devices, user input devices, memory devices, application programs, operating systems, wide area network (WAN) devices, etc. Similarly, plurality 108 of destinations 110(1−M) can include destinations that are internal, external, local, and/or remote with respect to gather system 102 and with respect to one another. Therefore, examples of potential destinations 110(1−M) can also comprise, but are not limited to at least intermittently wired or wirelessly coupleable internal or external hard/optical drives, local area network (LAN) devices, user input devices, memory devices, application programs, wide area network (WAN) devices, etc. In fact, any device that can engage in direct or indirect data communication with gather system 102 can serve as a potential source or destination.

In order to gather data from sources 106(1−N), gather system 102 interfaces directly or indirectly with each of sources 106(1−N). Gather system 102 can interface with sources 106(1−N) in a number of ways, including but not limited to establishing a network connection, establishing a bus connection, transmitting and or receiving data, negotiating a security routine, negotiating a commercial transaction, tracking or “monitoring” data transfers, via mobile code, via polling, etc. or some combination thereof. Gather system 102 can similarly interface with destinations 110(1−M). It is not necessary, however, for gather system 102 to interface with each of sources 106(1−N) and/or destinations 110(1−M) in the same manner, because sources 106(1−N) and destinations 110(1−M) can include systems of a widely varying nature. Gather system 102 can also adapt to one or more sources, destinations or couplings in conducting such interfacing via the exemplary mechanisms given below or any other suitable mechanisms in accordance with a particular application.

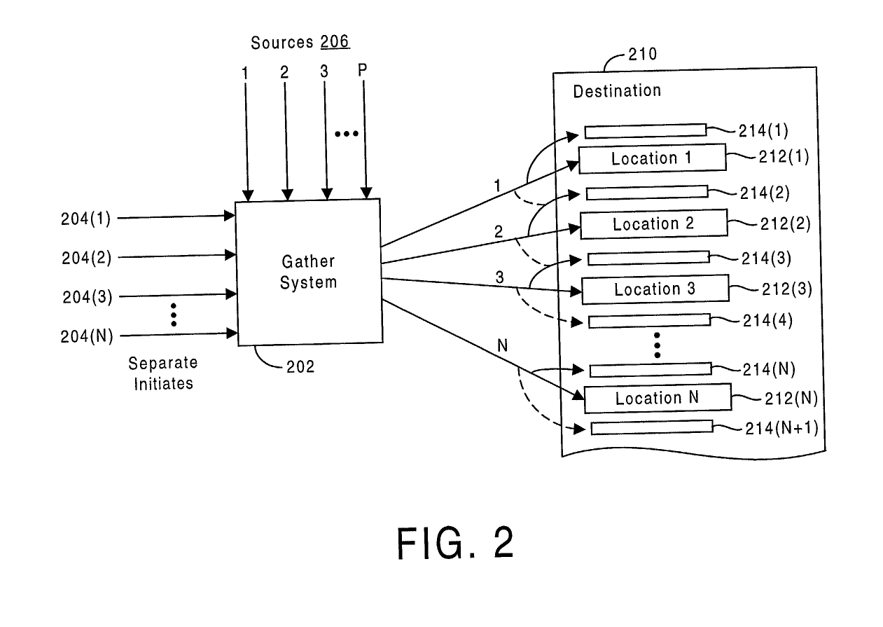

FIG. 2 diagrammatically represents an example of a gather system 202 sequentially performing gathering. Each of a plurality of arrows 204 (1−N) represents a separate, sequential initiate signal to gather system 202. Responsive to a first initiate signal 204(1), gather system 202 gathers data/information from any or all of a plurality of sources 206(1−P), and distributes a portion of the gathered data into a location 212(1) of destination 210. In addition, gather system 202 augments the gathered data by distributing additional separator data to a location 214(1). The separator data functions to segregate each gathered data set or data set portion(s) and can comprise a blank space, line, format change or any other suitable mechanism operable to facilitate data and/or information distinction/separation. Optionally, the separator data can include useful information, for example a title, a sequential number, a user input label, etc. (as might be suitable to a particular application). The dashed lines on the arrows pointing to separators 214(2−N+1) show how data separators may be inserted before each gathered data set, after each gathered data set, between gathered data portions, according to separation rules/criteria or some combination.

Gather system 202 gathers, processes and/or distributes data/information according to predetermined criteria, to facilitate a particular function. For example, gather system 202 may be implemented to provide Internet research tool operations. In this example, responsive to a user selecting a particular data block (e.g., a block of data with some factual information of interest to the researcher) and providing an initiate signal 204(1), gather system 202 gathers the selected data and any associated information (e.g., title, author, publisher, date, etc.) from sources 206(1−P), and deposits gathered data/information into location 212(1). As long as the desired gather system operation (e.g. data, information, destination, etc.) remains of the same general type, the gather criteria need not be changed. As a result, once gather system 202 is initiated, all the user need do is select subsequent data portions to be gathered and provide the subsequent initiate signal 204(2). Further, the augmentation of the data (e.g., the provision of separator 214(1)) allows the researcher to continue “gathering” further data blocks without worrying about unintended combining of gathered data or re-formatting the gathered data in destination 210.

As will become apparent in the discussion that follows, a gather system might also be configured to automatically (e.g. programmatically) “adapt” to changes in criteria discernable by the gather system (e.g. source, destination, data/information portion or type, processing results, host system changes, gather system use history, etc.). Thus, a gather system implementation can also allow a researcher to continue gathering further data blocks (with insertion of separators and/or other desirable gather system processing) despite such changes, and without requiring the user to explicitly select or otherwise modify gather criteria.

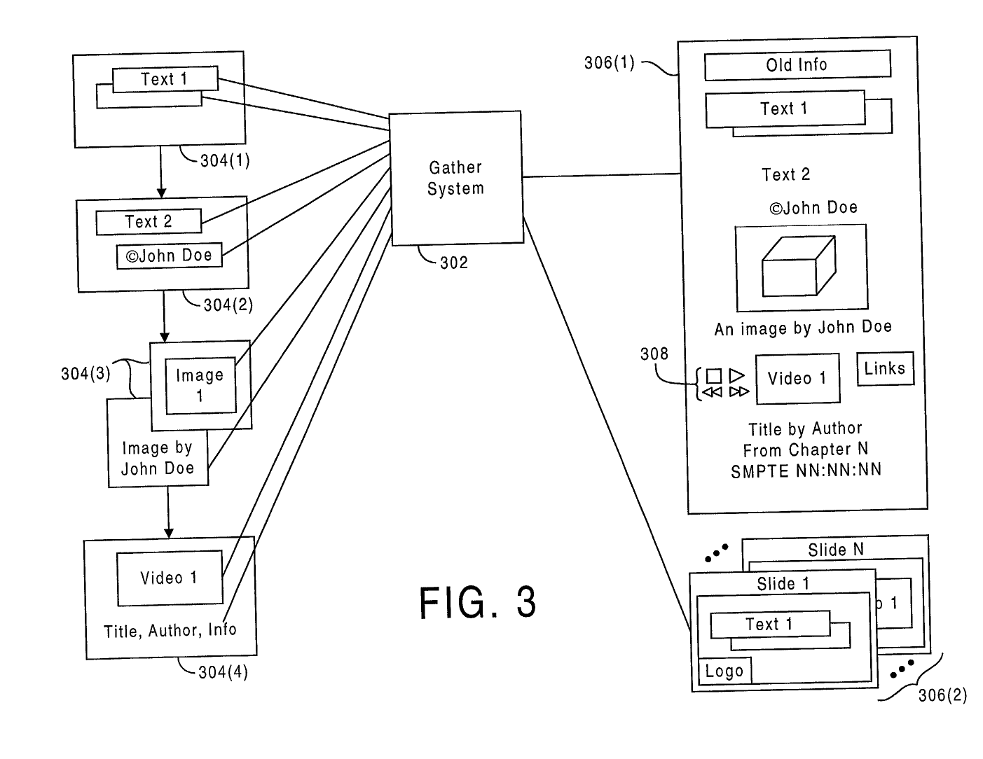

FIG. 3 illustrates an example of a gather system 302 gathering multimedia data/information from a plurality of sources 304(1−4), processing the data/information and distributing resultant gathered data into the multimedia document indicated as destination 306 (1) and the slide presentation indicated as destination 306(2). First, the user selects a text block “Text 1” from source 304(1); the user also typically initiates gather system 302 (or the gather system is automatically initiated). Gather system 302 then gathers the selected text block and information (here, additional text block “Text 2”), and distributes the gathered data to multimedia document 306(1) and to a first slide of slide presentation 306(2). Next, the user selects a text block from source 304(2), and gather system 302 gathers the text block and a copyright notice associated with the text, and distributes the text and the copyright notice to destinations 306(1−2). Next, the user selects an image from destination 304(3), and gather system 302 gathers the image along with a label, and distributes the gathered data to destinations 306(1−2). (Gather system 302 might also append suitable or specified text, such as adding “An image by” to a gathered author's name.) Finally, the user selects a video from source 304(4), and gather system 302 gathers the selected video along with information related to the video data, and distributes the gathered data to destinations 306(1−2).

Note that gather system 302 has also provided (i.e. or caused to be provided) the control features necessary to display the gathered video data. This illustrates an example of how gather system 302 can be configured to handle different types of multimedia data differently according to the particular data type. Further, this gather system feature is not limited to video data, but rather is possible for any recognizable type/attribute of data and/or information. (It will be appreciated that the term “multimedia” can refer to one or more data types either alone or in combination.)

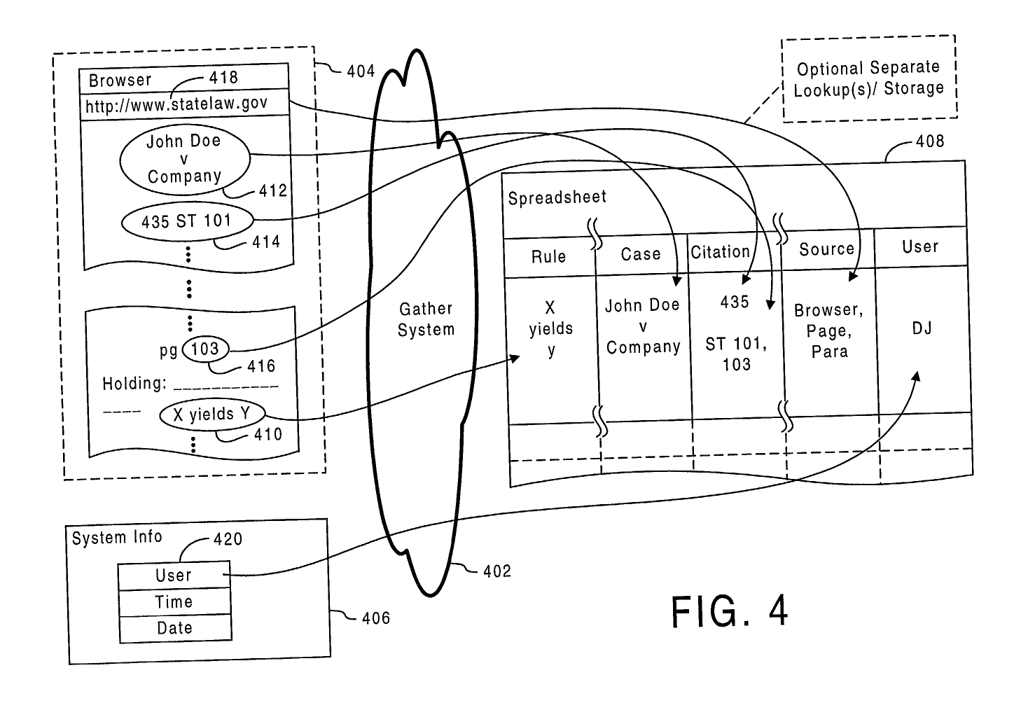

FIG. 4 illustrates an example of a gather system 402 gathering local and remote data and information, and processing and distributing gathered data into non-contiguous locations of an application program or other destination. In this particular example, gather system 402 facilitates legal (or other) research conducted via the Internet by gathering data and information from a web site 404 (in conjunction with a browser or other client) and the user's system, and processing and distributing the gathered data to discrete cells of spreadsheet program 408.

Data is gathered and distributed as follows. First, the user selects a desired passage 410 from the displayed case. Then, when initiated, gather system 402 gathers passage 410, along with case name 412 and documentary information including case citation 414, page number 416 of passage 410, web site address 418, and the user ID 420. Gather system 402 further parses the gathered data and distributes respective gathered data to corresponding cells of one row of spreadsheet 408. Gathering includes determining the data and corresponding information. Parsing and distributing further comprises combining and arranging the citation and page number, and distributing the gathered data, including the resultant citation plus page combination, into respective spreadsheet cells. Responsive to subsequent passage selections, gather system 402 gathers data and information, parses and distributes the subsequent gathered data to respective cells of a new row of spreadsheet 408, such that each selected passage results in a new row of data in spreadsheet 408.

More or less data then that shown may be gathered according to the particular needs of the user (e.g. in this case, client, billing or other local/remote information). Other information suitable to other uses might also be gathered (e.g. bibliography, other resources, contact information, etc.). Gather system 402 might further gather information at different times, perform security, a purchase transaction for the data/information, formatting, linking or other pre-, during- or post-processing; a gather system might further perform interfacing with a source, such as one or more web sites providing desired information (or destination), and/or might store information in a separate or linked manner (e.g. to a legal brief/memo, accounting department separate file, etc.), as given by the depicted optional separate lookups/storage. The information that is to be gathered, processing that is to be conducted and destination(s) to which the gathered data is to be distributed are determined in accordance with predetermined gather criteria (not shown). (The source is, in this example, given by user selection.) Examples of these and other operations, and the use of gather criteria are explained in greater detail hereinafter. Further examples will also become apparent in view of the discussion herein.

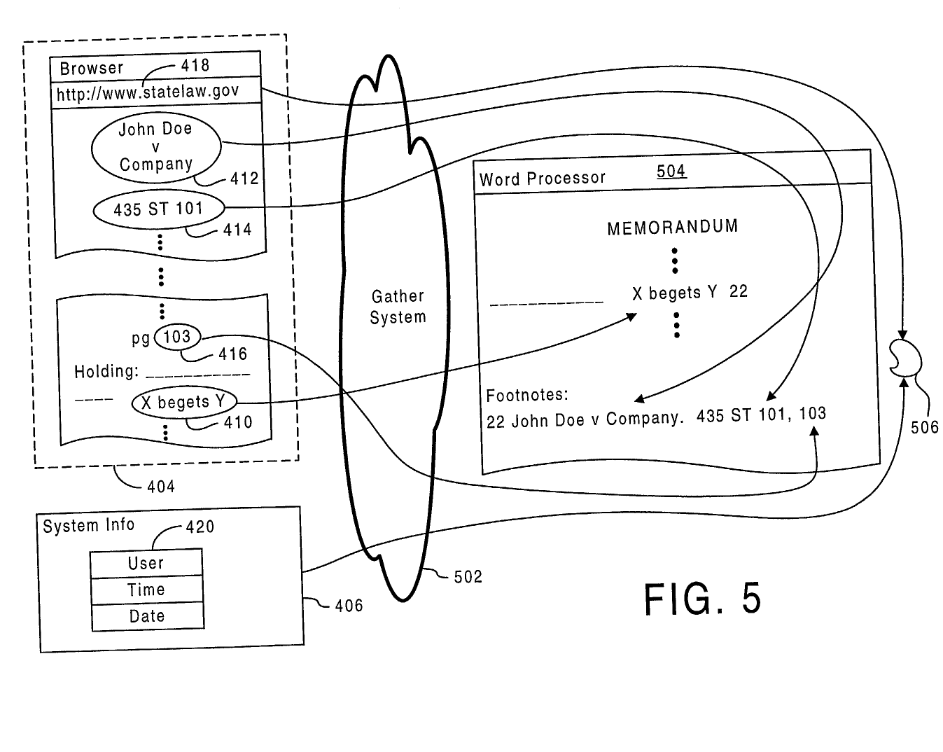

FIG. 5 illustrates another example of a gather system 502 gathering data from web site 404 and the user's system information 406, augmenting the gathered data, and distributing the gathered data, in this case, into a word processing document 504. Gather system 502 is substantially identical to gather system 402 of the previous example, except that different gather criteria are used, resulting in the different functionality of gather system 502.

In the example of FIG. 5, gather system 502 gathers the selected passage 410, along with documentary information including case name 412, case citation 414 and page number 416 of passage 410, as well as the web site address 418, and the user ID 420 (as described in the previous example). Gather system 502 then distributes the gathered data as follows. Gather system 502 places the selected text 410 in the body of a memorandum. Gather system 502 also inserts a footnote indice “22” after the text block, and inserts a footnote at the bottom of the page (e.g. via application program controls). Gather system 502 further distributes case title 412, citation 414, and citation page number 410 into the footnote. The web site address 418 and the user ID 420 can further be distributed into a hidden text field 506 of the word processing document 504, a profile, linked/separate file and/or other suitable location(s). This particular distribution of gathered data is shown by way of example only. Virtually any desired augmentation and distribution of the gathered data may be implemented by appropriately selecting/configuring the gather criteria and processing functions.

A particular set of gather criteria and/or data processing operations is referred herein as a “context”. For example, the gather criteria used to obtain the functionality of gather system 402 of FIG. 4 of gather system 502 of FIG. 5 could comprise a “legal research” context. In other words, ones of the same or different gather criteria can be determined in accordance with conditions within which the system is operating, system user, source, destination and/or other information forming a context (e.g., legal research, multimedia presentation, drafting, etc.). There are a myriad of ways that a context may be defined, selected, and used. For example, a user may record a series of actions, and then save the series actions as a context. The saved context may then be recalled and used when desired. Another example of defining a context would be through the use of default user preferences. As a further example, a gather system can include a number of predetermined contexts from which a user may choose. As yet another example, an artificial intelligence program or a rule-based program may monitor and analyze a users actions, source, destination, data, information, group and/or project, and automatically implement and/or store, for further use, an appropriate context based on the analysis. A combination of methods might also be used. (The above are only a few examples of the ways gather criteria sets can be implemented as contexts. Such examples are not intended to be exhaustive, as it is impossible to list all possible useful implementations.

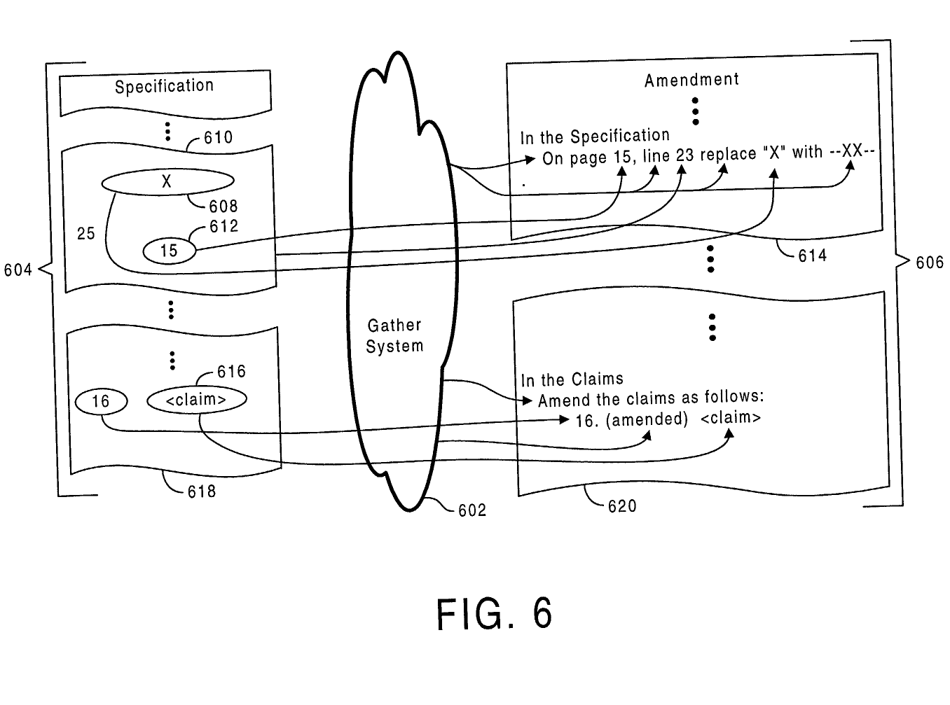

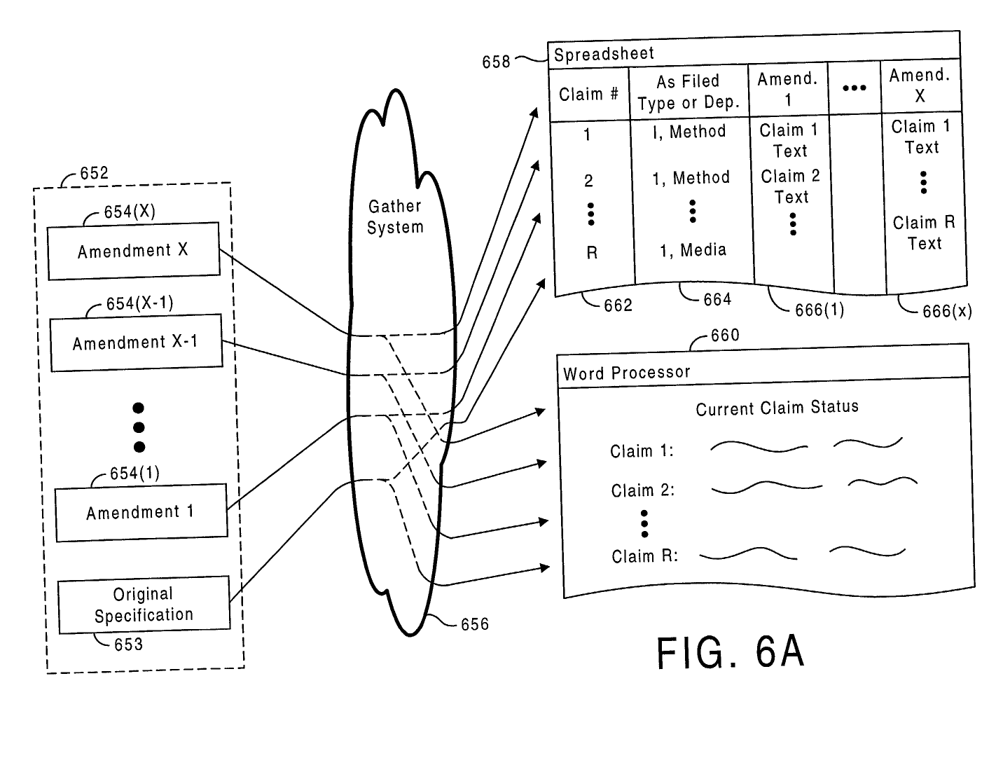

FIG. 6 illustrates an example of gather system 602 implementing a context and a subcontext. In this example, gather system 602 gathers data from a patent application specification 604 for use in the preparation of an amendment 606. When the user is in the process of drafting an amendment, gather system 602 loads a context (e.g., “amendment context”) which may include some generic gather criteria useful in preparing an amendment. The amendment context may be selected by the user, or may be automatically selected as a result of some particular action of the user (e.g., opening the specification document and/or the amendment document).

In addition to the more general amendment context, gather system 602 can implement different subcontexts. If, for example, the user selects a text block “X” 608 from a description portion 610 of specification 604, gather system 602, in accordance with criteria corresponding to a “specification” sub-context, gathers the selected text, an associated page number 612 and line number(s) corresponding to the text. Gather system 602 also augments and distributes the gathered data in a specification portion 614 of amendment 606. However, if the user selects a claim 616 from a claims section 618 of specification 604, then gather system 602, in accordance with a “claims” sub-context, gathers the selected claim language 616 and the associated claim number 620, and augments and distributes the gathered data in a claims section 620 of amendment 606. The selection of one of a number of sub-contexts can be made in a number of ways including, but not limited to, user selection, the placement of the cursor in amendment 606, and/or the location of the data selected from specification 604.

FIG. 6A illustrates an example of the distribution of gathered data to not strictly numeric summary and to current status forms. In this example, a source 652 (e.g., a client document directory) includes an original specification 653 for a patent application, as well as a plurality of amendments 654(1−X) filed in the case. Gather system 656 gathers the original claims from specification 653 and any amendments to the claims contained in amendments 654(1−X). Then gather system 656 further distributes the gathered data into a data summary (a claim chart 658 in this example), and a current status document 660.

Gather system 656 distributes the data into claim chart 658 as follows. Gather system 656 distributes the original claim numbers into a first column 662 (e.g. by parsing the claim portion of specification 654). Gather system 656 also uses a rule based algorithm to examine the preamble of each claim, and distributes augmented data (e.g., indication of claim type and dependency) into a second column 664. Gather system further, for each filed amendment, similarly determines each claim amendment (e.g. added, deletion or change) and distributes indicia of each such amendment into a row corresponding to the amended claim, and one of columns 666(1−X) corresponding to the particular one of amendments 654(1−X) from which the amendment was gathered. The resulting claim chart 658 provides a convenient summary of all amendments to the claims.

Gather system 656 is further capable of distributing a clean, current copy of each claim into status document 660 (and/or claims with amendment indicia). For each claim, gather system 656 identifies the most recent amendment made to the claim (or alternatively, each amendment made to the claim), and then processes the amendment according to predefined rules to produce a clean copy of the claim. For example, gather system 656, when configured according to US patent practice, removes any bracketed text from the amended claim and reformats underlined text to normal text, in accordance with known rules for amending patent claims. Gather system 656 also distributes the manipulated data (cleaned-up claim text) to a corresponding location in status document 660. For claims that have not been amended, gather system 656 simply distributes a copy of the claim gathered from specification 653 to status document 660.

Gather system 656 is further capable of gathering linking information and distributing (active or inactive) indicia of such linking information. In FIG. 6A, for example, gather system 656 can add active links to claims indicated in claim chart 658, such that selecting an indicated claim or amendment can automatically present (e.g. display) associated amendments, or further, associated claim-amendments within the amendment-documents. (Gather system 656 might also or alternatively provide inactive or active indicia separately, such as was already discussed.)

It will be appreciated that gather system 658 is capable of gathering original data and modifications information or indicia thereof, processing the data and information and distributing summary information or indicia thereof, where the data, information and indicia are of various multimedia types or relate to other uses (e.g. a plan versus actual, catalogue, graphics, video, audio, etc). The data and information can further be identified by gather system 658 according to any associating attributes (e.g. client, matter, project, dates, location, flag, link, etc.), and can actually be differently located (e.g. local and remote) so long as they can be determined by gathering system 658.

Another advantageous capability of gather systems in general, and gather system 656 in particular, is the ability to create and insert links in the distributed data. For example, because gather system 656 can also gather the original location (e.g., file name, page number, line number, etc.) of the gathered data, links can be inserted in claim chart 658 which retrieve the original data (e.g., original claim language, claim amendments, etc.) from the original source 652. Further, because gather system 656 knows the destination of the distributed data, links between distributed data portions can also be included in the distributed data. For example, a link retrieving the most current amendment from claim chart 658 can be included with the current text of each claim in status document 660. Thus, by selecting the link for a particular claim, the user could retrieve the latest amendment to that claim. The foregoing specific examples show that links can be used to link distributed data to a source or to distributed data in another location. It should be understood, however, that the use of links is not so limited. In particular, links can be used which link distributed data to any other desirable source, destination, location, and/or application.

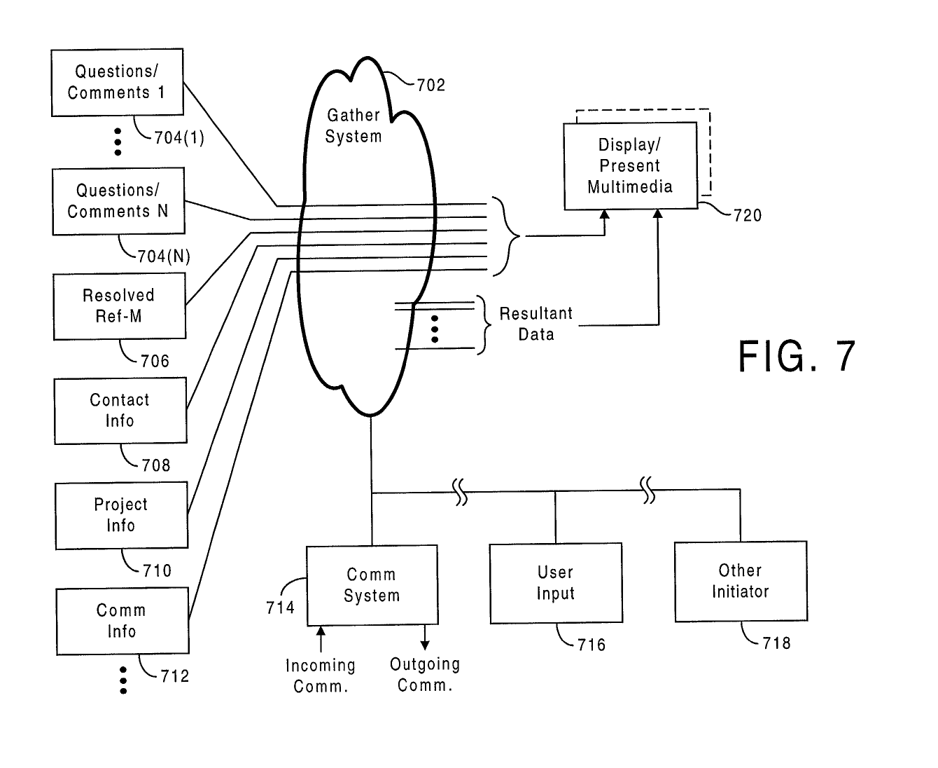

FIG. 7 illustrates a data gathering system 702 being incorporated in an example system (e.g., an office computer, communication system or the like). Once initiated, for example, upon a received telephone call, email or project update, gather system 702 gathers information from a plurality of sources, processes the gathered data, and distributes the processed data to one or more destinations. Potential data/information sources can include a plurality of questions/comments 704(1−N), previously resolved/referred issues 706, contact information 708, project information 710, and communications information 712, among others.

Questions/comments 704(1−N) can, for example, include a knowledge base of prior questions or comments to or from clients (e.g. email, appointments, messages, electronic files, notes, a database, and so on, or some combination). Resolved/referred issues 706 can include a knowledge base of issues previously resolved for clients or referred out for further action. Contact info 708 can include a contact list, spreadsheet, communication system, database, merge source, or address book (as is typically stored on an office computer), or some combination. Project info 710 can include a knowledge base of stored information corresponding to a client's projects (e.g., time/expenses, priority, etc. for particular projects). Communications information 712 includes information regarding whether gather system 702 will receive, ignore, interrupt, etc., present and subsequent communications.

While the above examples of potential data sources include types that are typically found locally on an office computer for other purposes, it should be understood that the range of data sources available to gather system 702 is not so limited. Rather, as described with reference to previous examples, gather system 702 may gather data/information from any available local or remote data/information source; mobile code might also be utilized.

Gather system 702 can receive data/input and/or be initiated by a communications system 714, user input device 716, and/or some other initiator 718. Communication system 714 can accept and/or establish communication links including, but not limited to, voice and data telephone, cable and/or satellite connections. User input device 716 (e.g., a keyboard, a microphone, etc.) allows a user to provide input and commands to gather system 702. Other initiator 718 illustrates that virtually any desirable signal could be used to initiate gather system 702.

Gather system 702 operates, in one example situation, as follows. An incoming call from a client via communication system 714, and the associated caller ID data initiates gather system 702. Using the caller ID data as the previously described “selected” data, gather system 702 identifies the caller from the contact information data source 708, and gathers information from any or all of the other data sources according to predetermined “call answer” gather criteria. Particular information can, for example, be identified directly or indirectly as corresponding to any one or more suitable attributes or combinations of attributes (e.g. storage location(s), client/project identifying information, etc.) Email, memoranda or other documents, or other communication/project data, user input, etc. can also serve as “selected” data or for gather initiation.

In the present example, gathered data can be distributed to a display or other suitable local/remote presentation mechanism 720, allowing a user to see the identity of the caller along with all or some of the gathered data (e.g. as a summary, more complete presentation, linked frames, windows, etc.). Gather system 702 can also perform processing, such as the above discussed parsing/combining, formatting and/or linking among others. For example, gather system 702 might gather data/information (e.g. open invoices for a calling client), produce an organization/summary of the data/information (e.g. total the invoices), and then present the summary (e.g. display the total balance due by the client). Gather system 702 might also present or cause the resultant data (i.e., data resulting from gather system 702 processing the gathered data) to be presented in one or more alternative forms (e.g. as graphics, animation and/or some other multimedia.

It should also be noted that gather system 702 can distribute gathered data to more than one destination. For example, gather system 702 can present gathered/resultant data, via communications system 714, to several remote systems to, for example, host a conference call or similarly/differently present gathered/resultant data or make such data available to local/remote participants, and/or store/print gathered data, among other options.

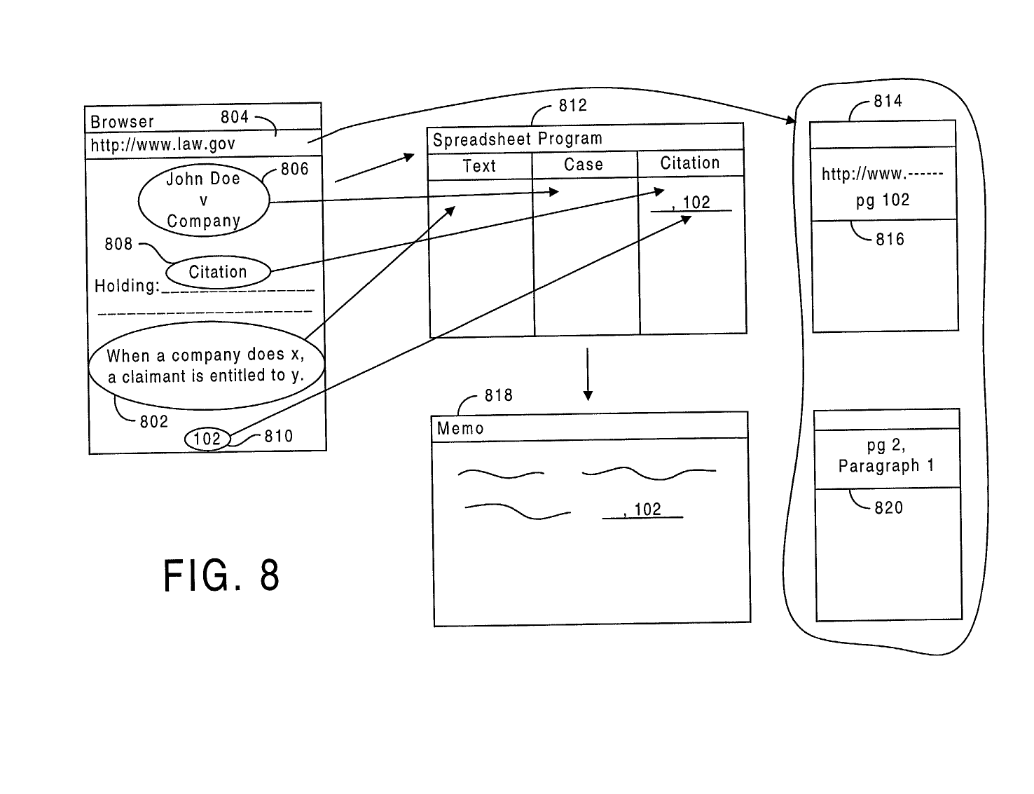

FIG. 8 illustrates an example of a two-step gather process performed by a gather system (not shown). Here, responsive to a user selecting a text block 802, the gather system gathers the selected text along with the web address 804, case title 806, citation 808, and current page number 810. The gather system also distributes text 802, case title 806, and page number 810 to respective cells of a spreadsheet 812. Additionally, the web address 804 and the page number 810 are distributed to another destination 814 at a location 816. Gather system further gathers data from the spreadsheet 812, and then distributes the gathered data to a memorandum 818. As the gathered data is distributed to memorandum 818, the gather system makes an entry in a location 820 corresponding to location 816 of destination 814. Together, entries 816 and 820 facilitate indexing between the entries in spreadsheet 812 and memorandum 818.

The above-described two-step gathering process has advantages over a one-step gather process in some circumstances. For example, spreadsheet 812 might be compiled while a user is performing time-sensitive on-line research. Afterwards, the researcher can take the time to carefully review and revise the content of spreadsheet 812, prior to gathering the content of spreadsheet 812 to memorandum 818.

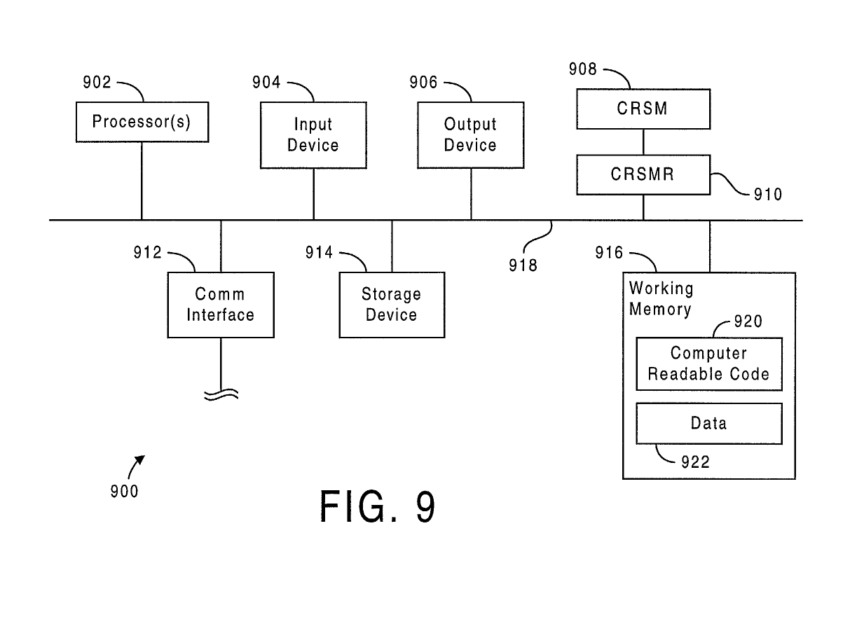

FIG. 9 illustrates an exemplary computing system 900, such as a personal computer (“PC”) or other suitable “processing” system, that can comprise or host one or more gather system elements. While other application-specific device/process alternatives might be utilized, such as those already noted, it will be presumed for clarity sake that gather system elements are implemented by one or more processing systems consistent therewith, unless otherwise indicated.

As shown, computer system 900 comprises elements coupled via communication channels (e.g. bus 918) including one or more general or special purpose processors 902, such as a Pentium® or Power PC®, digital signal processor (“DSP”), or other processing element(s). System 900 elements also include one or more input devices 904 (such as a mouse, keyboard, joystick, microphone, remote control unit, tactile, biometric or other sensors, and so on), and one or more output devices 906, such as a suitable display, joystick feedback components, speakers, biometric or other actuators, and so on, in accordance with a particular application.

System 900 elements also include a computer readable storage media reader 910 (“CRSMR”) coupled to a computer readable storage medium 908 (“CRSM”), such as a storage/memory device or hard or removable storage/memory media; examples are further indicated separately as storage device 914 and memory 916, which can include hard disk variants, floppy/compact disk variants, digital versatile disk (“DVD”) variants, smart cards, read only memory, random access memory, cache memory or others, in accordance with a particular application. One or more suitable communication devices 912 (“Comm Interface”) can also be included, such as a modem, DSL, infrared, etc. for providing inter-device communication directly or via suitable private or public networks, such as the Internet. Working memory 916 is further indicated as including computer readable code 920 and data 922, which can, for example, include an operating system (“OS”), application programs, mobile code, data, or other information for implementing or use in conjunction with a gather system, and which might be stored or loaded therein during use.

System 900 element implementations can include hardware, software, firmware or a suitable combination. When implemented in software (e.g. as an application program, object, downloadable, servlet, and so on, in whole or part), a system 900 element can be communicated transitionally or more persistently from local or remote storage to memory for execution, or another suitable mechanism can be utilized, and elements can be implemented in compiled, simulated, interpretive or other suitable forms. Input, intermediate or resulting data or functional elements can further reside more transitionally or more persistently in a storage media or memory, (e.g. storage device 914 or memory 916) in accordance with a particular application.

Portions of gather system embodiments can also be implemented as one or more low-level processes linkable to or forming part of a suitable operating system or OS-like process. Such an implementation might thus benefit from reducible delays and system-wide availability, among other benefits. (Any OS or programming languages capable of operating in accordance with the teachings herein can be utilized.

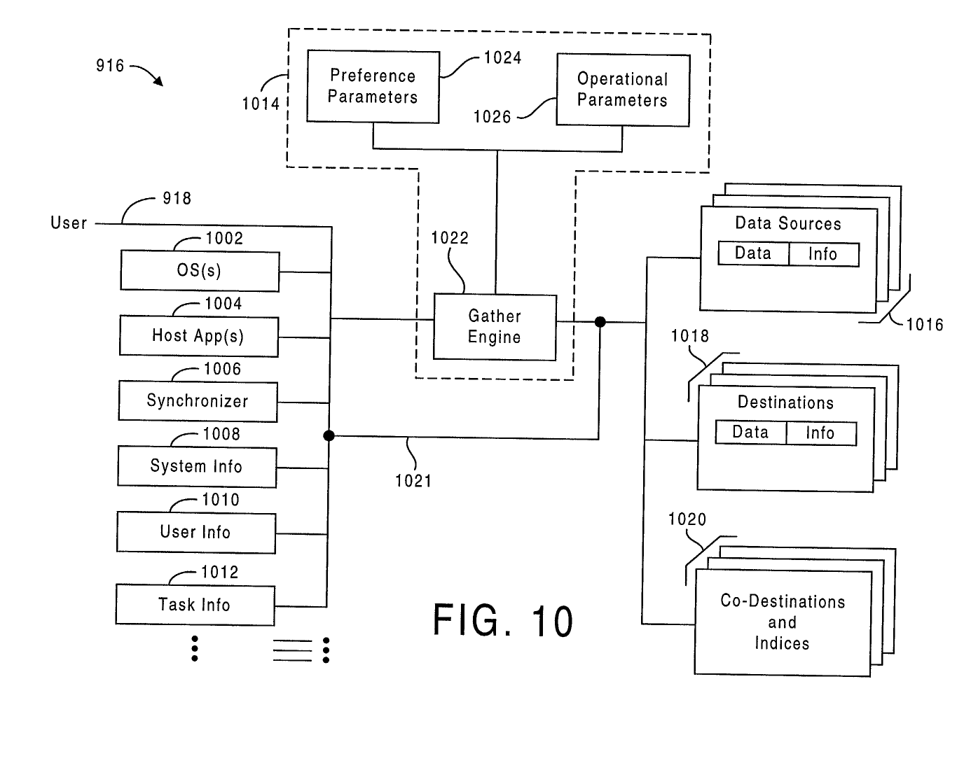

FIG. 10 illustrates a larger network or local system incorporating a gather system. In a local system, such as the processing system of FIG. 9, FIG. 10 elements might, for example, be included within working memory 916 during operation of system 900. Working memory 916 includes operating system(s) 1002, host applications 1004, synchronizer 1006, system information 1008, user information 1010, task information 1012 and gather system 1014. Also included are a plurality of data sources 1016, a plurality of destinations 1018, and a plurality of co-destinations and indices 1020, all interconnected by memory bus 1021. Host applications 1004, synchronizer 1006, system information 1008, user information 1010, and task information 1012 are not unlike similar code modules of known systems, except that, in the present example, one or more of host applications 1004 (e.g., word processor, spreadsheet, etc.) are modified so as to be able to initiate, or be initiated by, gather system 1014. (It will be appreciated that gather system 1014 might also be implemented to monitor system 916 activity and exchange data/information such that gather system operation can be effectuated without modification of host applications or OS 1002.)

In this example, gather system 1014 is an independently implemented, globally available component that can operate in conjunction with other programs including, but not limited to operating system 1002 and host application programs 1004. However, it should be understood that gather system 1014 may also optionally be incorporated into one or more of operating system 1002 and host applications 1004 in whole or part. As yet another alternative, gather system 1014 can also be implemented distributively across a plurality of at least intermittently available systems and/or might utilize mobile code in whole or part. Further, gather system 1014 can also be embodied in hardware, software, firmware, or some combination thereof.

Gather system 1014 includes a gather engine 1022, preference parameters 1024, and operational parameters 1026. Gather engine 1022, when initiated, is capable of gathering data/information from one or more of data sources 1016, processing the gathered data, and distributing the gathered data to one or more of destinations 1018, co-destinations and indices 1020 in accordance with gather criteria corresponding to parameters stored in preference parameters 1024 and operational parameters 1026.

As shown in FIG. 10, data sources 1016, destinations 1018, and co-destinations and indices 1020 are all resident in working memory 916. However, this simple example is provided so as not to unnecessarily obscure the present invention, and should not be construed as a limitation of the present invention. As indicated with respect to the several previously discussed examples, gather system 1014 is capable of gathering data from, and distributing data to, any accessible source or destination, whether internal, external, local, or remote. Therefore, it should be understood that one or more of data sources 1016, destinations 1018, and co-destinations and indices 1020 can be internal, external, local, and/or remote with respect to gather system 1014. One or more of elements 918 and 1002 through 1012 might also operate as data sources 1016, destinations 1018, co-destinations and/or indices 1020.

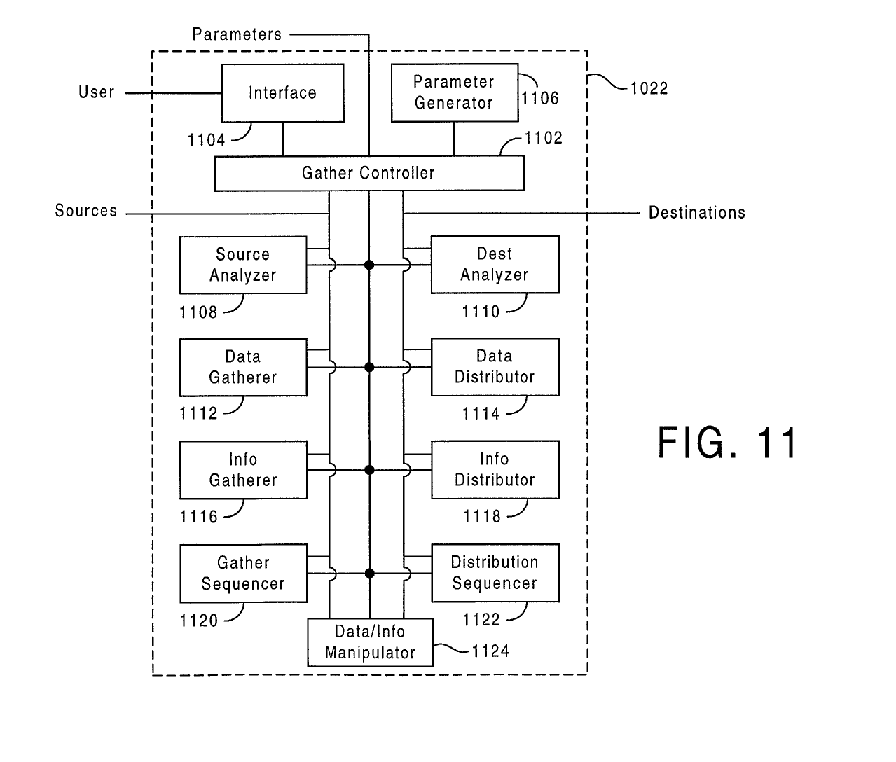

FIG. 11 illustrates an example in which gather engine 1022 (FIG. 10) includes the following components: gather controller 1102, interface 1104, parameter generator 1106, source analyzer 1108, destination analyzer 1110, data gatherer 1112, data distributor 1114, info gatherer 1116, info distributor 1118, gather sequencer 1120, distribution sequencer 1122, and data/info manipulator 1124. These operational components of gather engine 1022 are shown by way of example only. Those skilled in the art will understand that the particular components of gather engine 1022 are merely representative of the functional aspects of gather engine 1022, and are not therefore essential elements of the invention. The actual computer-readable code that makes up gather engine 1022 and gather system 1014 may or may not be organized as shown in this example. Rather, given the description of the operation and functionality of the various gather system examples according to the present invention, it is within the ability of one skilled in the art to write code, build hardware and/or some combination to produce functionality consistent with the teachings herein.

Gather controller 1102 provides for coordinating and controlling the overall operation of gather engine 1022. Interface 1104 is operative to facilitate user participation and/or user feedback in conjunction with parameter/context creation, modification and/or selection or otherwise with gather system operation. Parameter generator 1106, responsive to preference parameters 1024, operational parameters 1026, source analyzer 1108, destination analyzer 1110, and/or user input, is operative to generate gather criteria for use by gather controller 1102 during gather operations. In a simpler embodiment, parameter generator 1106 provides one of a plurality of stored gather criteria sets (“contexts” and/or “sub-contexts”) that are selectable by the user. In other embodiments, contexts/sub-contexts and/or parameters can further be automatically selectable in accordance with source, destination, data/information portion, user, history or other determinable attributes. In further embodiments, user/system modification can also be provided (e.g. as already discussed).

Selection/modification of a context or determination of parameters by parameter generator 1106 can utilize an analytical algorithm (e.g., rule-based, artificial intelligence, etc.) that considers information from one or all of preference parameters 1024, operational parameters 1026, source analyzer 1108, and destination analyzer 1110. Parameter generator 1106 can also generate gather criteria dynamically, providing a portion of the gather criteria when the gather process is initiated, and providing additional or substitute gather criteria depending on information (e.g., availability of data, content of gathered data, etc.) received before during or after the gather process has begun but prior to use. Mobile code/data can also be utilized in conjunction with creation, modification and/or selection.

Source analyzer 1108 provides for analyzing features (e.g., program type, availability, address, structure, resources, format, etc.) of potential data sources. Destination analyzer 1110 analyzes similar, but not necessarily identical, features of potential destinations. Results of these analyses are then made available to other components of gather engine 1022 as needed.

Data gatherer 1112 gathers data selected by the user during the gather process. Info gatherer 1116 gathers information or “other data” according to the gather criteria from one or more sources. Gather sequencer 1120 controls the manner (e.g. sequence) in which data and information are gathered or other processing is conducted during a gather operation, and/or tracks information relating to gather operation.

Data distributor 1114 distributes the gathered data to one or more destinations, as indicated by the gather criteria. Similarly, information distributor 1118 distributes the gathered information to one or more destinations according to the gather criteria. Distribution sequencer 1122 controls the manner (e.g. sequence) in which data and information are distributed or other processing is conducted in conjunction with distribution of gathered data, and/or tracks information relating to distribution in conjunction with gather operations.

Data/info manipulator 1124, responsive to the gather criteria, is operative to perform desired operations (e.g., mathematical, data augmentation, reformatting, parsing, etc.) on data/information or in conjunction with gathering, processing or distribution. Operations performed by data/info manipulator 1124 include pre-, during-, and post-gather operations, as well as pre-, during-, and post-distribution operations.

Gather-based operations can include, but are not limited to the following. Pre-gather operations can, for example, include determining gather criteria for gathering, negotiating logon, security/authentication, project, (pre)transaction, source analysis and/or dynamic information gathering (see below) and so on. During gather processing can include information determination, code/data exchange and/or data/information manipulation better conducted at this point (e.g. with regard to combinable, specially processed data/information), and so on. Post-gather operations can include transaction (or confirmation thereof), data and/or information parsing/augmenting and so on. Other gather-based processing will also be apparent in view of the teachings herein (only a few of which might be specifically noted herein).

Distribution-based operations can include, but are not limited to the following. Pre-distribution operations can, for example, include determining gather criteria for distributing, destination negotiation/analysis (e.g. appropriate spreadsheet columns or other parameters not yet known), formatting, opening files and/or communication channels, summarizing and/or reporting (e.g. of transaction costs) if not done later, decryption, and so on. During distribution operations can include determining any remaining information adding, deleting and/or further manipulation, application, file and/or communication channel switching, and/or combining, and the like. Post distribution operations can include providing or otherwise causing gathered data manipulation tools to be provided, closing files, communication channels, compositing, converting or conducting further manipulation of or spacers for gathered data, and/or providing any applicable user feedback not yet provided, and so on. Other distribution-based processing will also be apparent in view of the teachings herein (only a few of which might be specifically noted herein).

While processing algorithms or tools can be contained within data/info manipulator 1124, other processing resources (e.g., supplemental text, source/destination mobile code support, etc.) can also be stored elsewhere (e.g., operational parameters 1026), and retrieved or otherwise acquired in accordance with particular implementation considerations (e.g. see below).

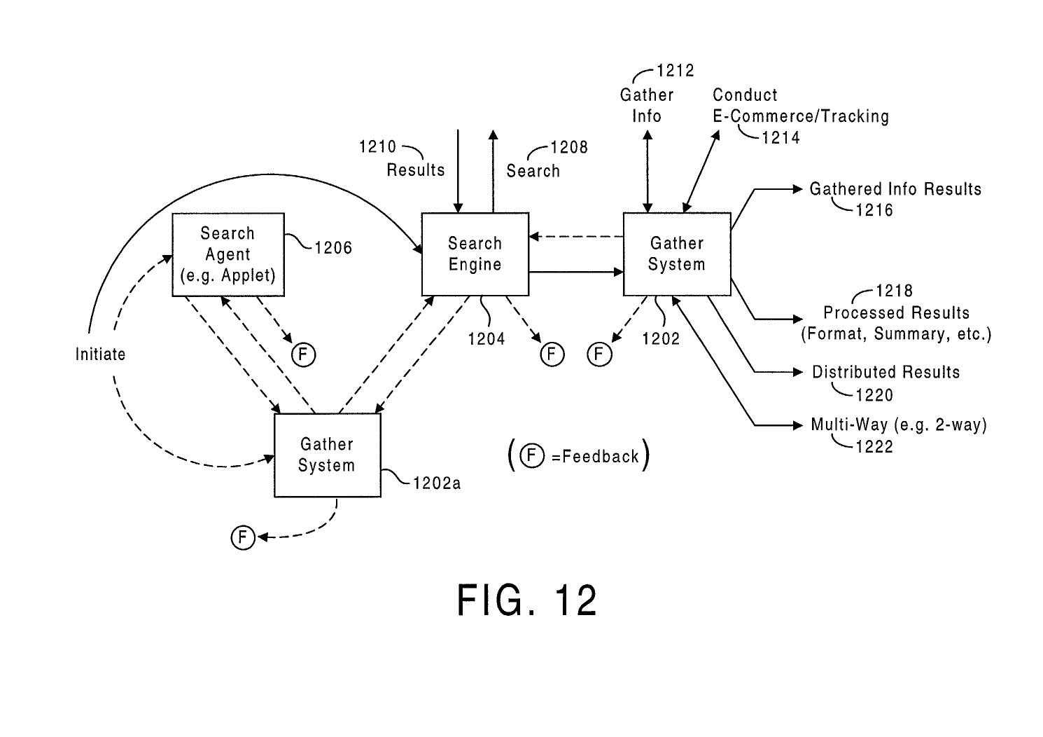

FIG. 12 illustrates exemplary alternate uses of gather systems 1202 and/or 1202a in conjunction with a search engine 1204 and/or a search agent 1206. In one embodiment (illustrated by the solid arrows), a search is initiated by a user by submitting the search “directly” to search engine 1204 (i.e. rather than via a gather system). Search engine 1204 then performs the search 1208, receives the results 1210, and provides the results to gather system 1202. Gather system 1202 can then gather additional information 1212 (e.g. for documenting or otherwise supporting search results), conduct e-commerce or tracking operations 1214 (e.g., pay for research/searches, etc., see above), produce gathered information results (e.g., to user who submitted original search request, etc.), produce processed results 1218 (e.g., format, summary, otherwise combining, deleting/modifying, etc.), distribute results 1220 (e.g. to more than one location, with a particular layout, etc.), or engage in multi-way gather operations 1222 (e.g. initiating a further search for other information, negotiating, etc.), according to predetermined gather criteria (depending for example on the format of the search results, destination, history, etc.). The foregoing list of potential functions of gather system 1202 is provided by way of example only, and is not intended to be exhaustive. Rather, gather system 1202 may be configured to perform any of the gather operations described herein.

According to an alternate scenario (dashed lines), the user submits a search request directly search agent 1206, which in turn carries out the search and provides the results to gather system 1202a. In this scenario, gather system 1202a functions similar to gather system 1202 described in the previous example.

According to yet another alternate scenario (dashed lines), the user submits the search request “directly” to gather system 1202a (i.e. rather than via a search engine). Gather system 1202a then conducts a gather operation using the submitted search terms as the selected data, and distributes the gathered data (e.g., reformatted search request, augmented search request, multiple search requests, etc.) to either search engine 1204 or search agent 1206. Of course the gathered data could be distributed to additional destinations (e.g., search log, etc.) as well. When search results are returned to gather system 1202a, additional gather operations (e.g., gathering web pages associated with links in search results, formatting, etc.) can be performed on the search results. Multiple gather systems can also be used, for example, to more specifically handle search engine use, to provide more desirable (e.g. context based) distribution and/or distribution-based processing, and/or to conduct more desirable (e.g. use directed) gathering, or gather-based processing of data/information.

In view of the foregoing examples of using a gather system in conjunction with a search engine, it should be apparent that a gather system may optionally be incorporated into a search engine, on either the source side or the destination side (e.g. user side and server or application/OS side) of the search engine.

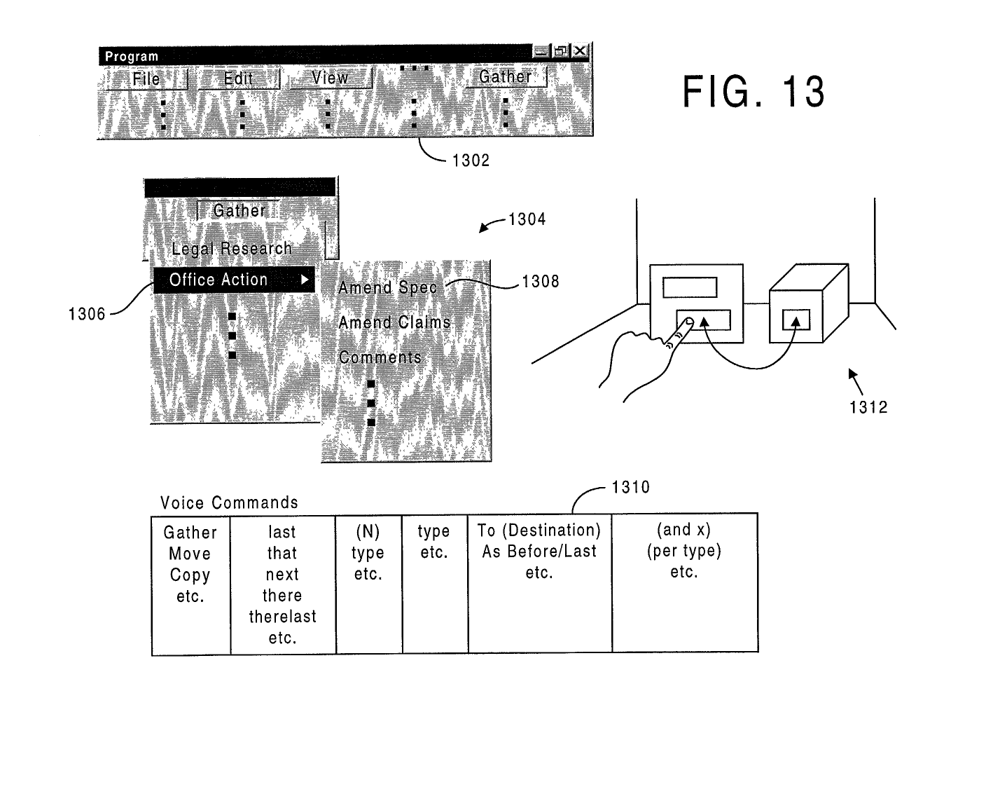

FIG. 13 illustrates examples of user interfaces suitable for use with gather system embodiments according to the present invention. These interfaces are provided by way of example, and the present invention is in no way limited to the use of any particular interface. In interface 1302, a gather command is included in the menu bar (or button bar) of an application program. This type of interface is particularly useful in application programs specifically designed to take advantage of the benefits offered by a globally available gather system.

Interface 304 includes a pop-up menu that can be displayed by, for example, right mouse clicking or other (e.g. pen/glove) implementations. Note that the depicted popup menu includes predefined contexts (e.g., “Office Action” 1306) from which a user can choose, as well as a list of available sub-contexts (e.g. “Amend Spec” 1308), that are displayed when the cursor is placed over or clicked on a particular context.

Table 1310 lists example voice commands that can be used with a speech recognition interface to invoke the gather system. For example, the command: “Gather last (n) rows to (spreadsheet) and (text-destination)” would cause the last (n) rows of data in a current source to be gathered and distributed to an (optionally named) spreadsheet and an (optionally named) text document (typically in a manner more suitable to such destinations, which might also be expressed as part of the command).

As yet another example, interface 1312 shows a virtual or augmented reality interface, whereby data is gathered using controls suitable to a three-dimensional layout. The foregoing interface examples are only a small sample of the interfaces that can be used with a gather system.

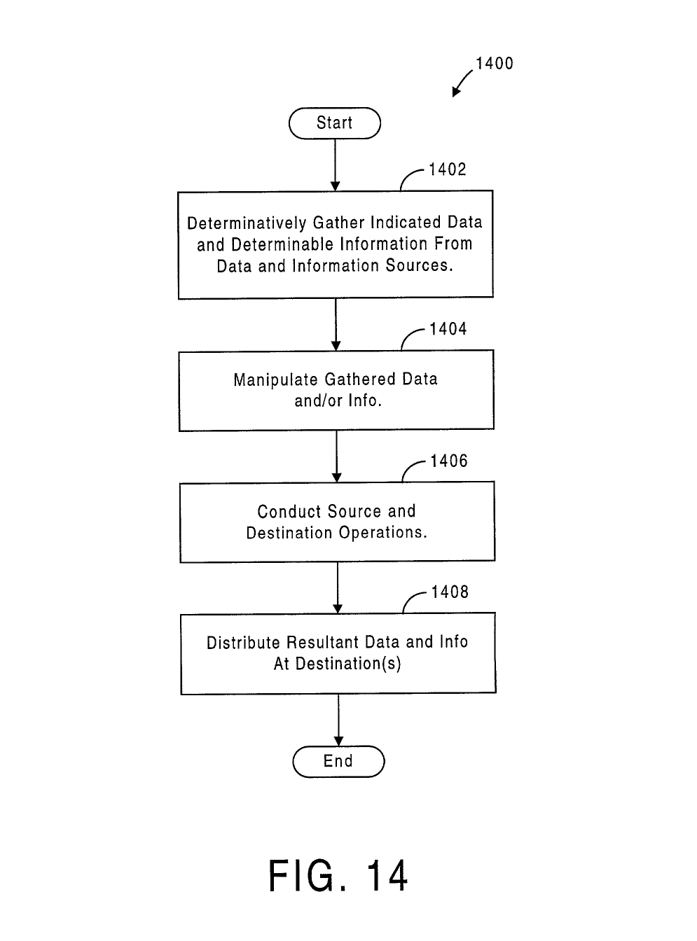

The FIG. 14 flowchart illustrates a data gathering method 1400 according to an enbodiment of the invention. In step 1402, gather system 1014 gathers determined (e.g., user or other system selected) data and determinable information from one or more sources. In optional step 1404, gather system 1014 manipulates (e.g., formats, parses, etc.) the gathered data and/or information. In optional step 1406, gather system 1014 conducts source and/or destination operations (e.g., negotiate security, make tracking log entries, etc.). Finally, in step 1408, gather system 1014 distributes the gathered and/or manipulated data and information to one or more destinations.

It should be noted that steps of method 1400 (as well as steps of other methods disclosed herein) need not be performed in the particular order shown. For example, in some circumstances it may be necessary to conduct a source operation (e.g., negotiate security) prior to gathering data. In that case, step 1406 may be performed before step 1402. If a destination operation (e.g., launch an application program, open a particular file, etc.) is required prior to distributing gathered data, then such destination operations may be conducted before, during or after the data is gathered.

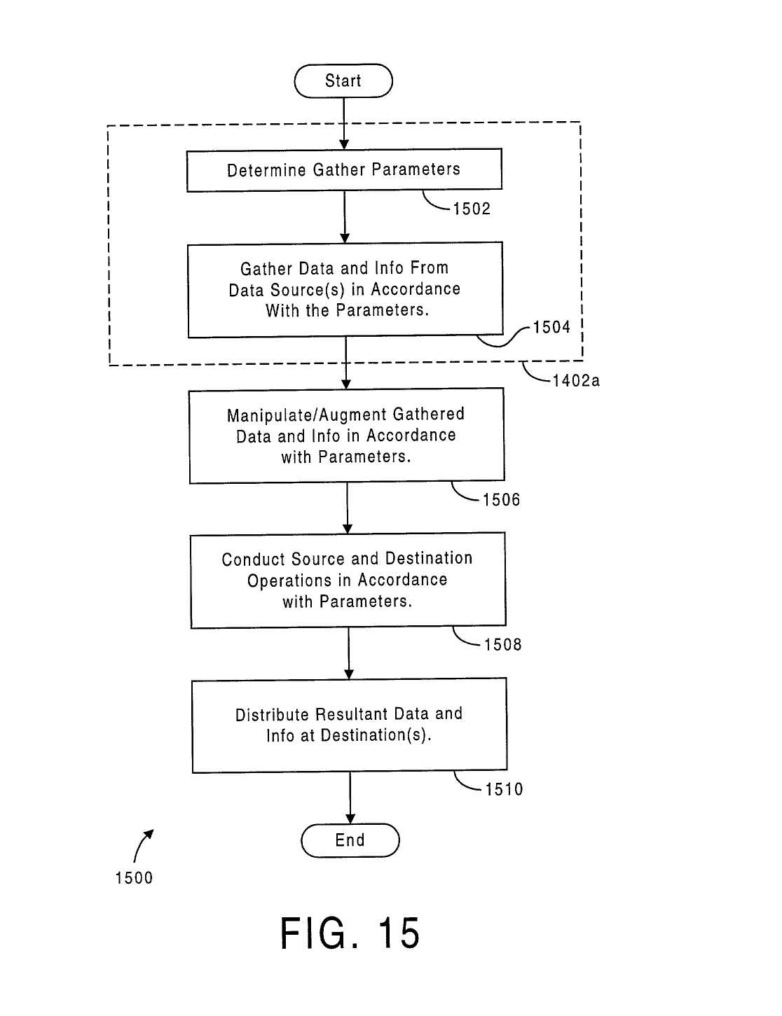

FIG. 15 is a flowchart illustrating a further data gathering method 1500 according to an embodiment of the invention. In step 1502, gather parameters (“criteria”) to be used for a subsequent gather operation are determined (e.g. by parameter generator 1106). In step 1504, data and information from one or more data sources are gathered in accordance with the gather parameters (“IAWP”), e.g. by data gatherer 1112. In step 1506, gathered data is manipulated (e.g., reformats, etc.) and/or augmented (e.g., inserts text, etc.) IAWP, e.g. by data/information manipulator 1124. In step 1508, any applicable source and/or destination operations are conducted IAWP, e.g. by gather controller 1102. Finally, in step 1510, the gathered, manipulated and/or augmented data is distributed to one or more destinations IAWP, e.g. by data distributor 1114.

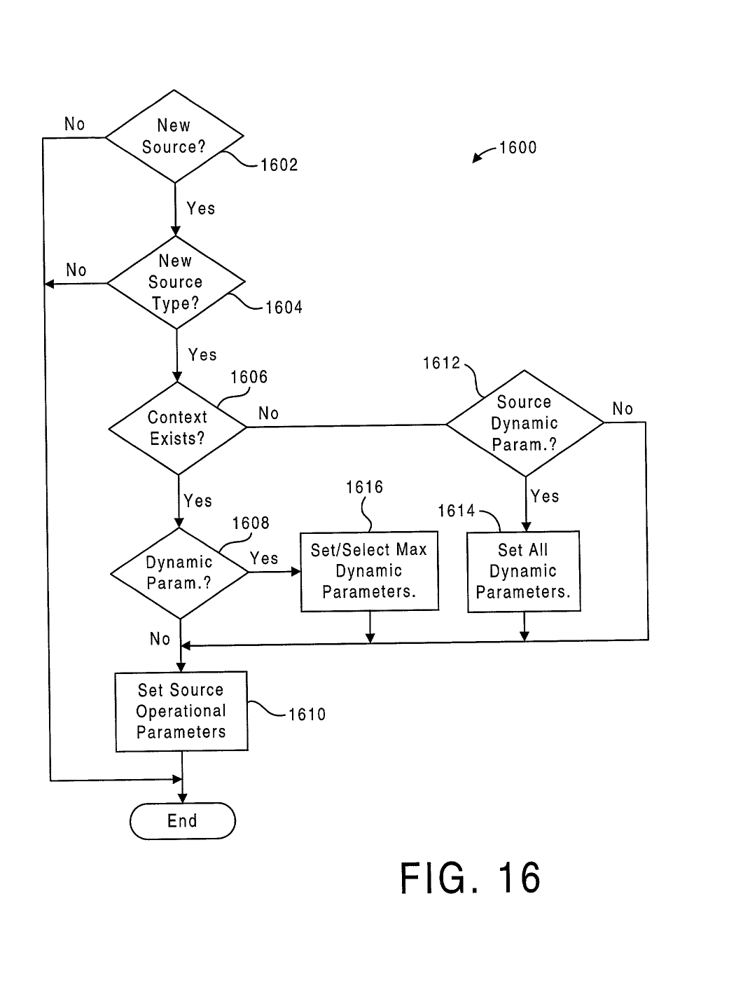

FIG. 16 is a flowchart illustrating an exemplary method 1600 of performing step 1502 (determining gather parameters) of method 1500 (FIG. 15). As described below, method 1600 includes steps for setting dynamic as well as static parameters. Dynamic parameters are parameters that relate to data that may be only intermittently available. For example, a live Internet broadcast may include streamed data that is displayed, but not stored as it is received or not stored in a manner such that it can assuredly or conveniently be retrieved as needed. (Such broadcast data might, for example, be cached, but only temporarily, not always or in a manner otherwise inconvenient or unsuitable to a particular application. Data/information provided only within a title page of a web document where data is gathered from another page is yet another example.) Dynamic parameters should be determined prior to such data becoming available so that corresponding dynamic data can be gathered while the dynamic data is available. Contrastingly, static data refers to data that will or expected to be available at the time of gathering.

In step 1602, source analyzer 1108 determines whether the potential data source has changed since the last gather operation. If not, the previous gather parameters are retained, and method 1600 ends. If the potential data source has changed, then in step 1604, source analyzer 1108 determines whether the new data source is of a new type. If the new data source is not of a new type, then the previous gather parameters are retained, and method 1600 ends. However, if the new data source is of a new type, then in a third step 1606 parameter generator 1106 determines whether a predetermined context (gather parameter set) exist for the new data type. If a predetermined context does exist for the new source, then in a fourth step 1608, parameter generator 1106 determines whether there are any dynamic parameters included in the predetermined context. If there are no dynamic parameters included in the predetermined context, then in a fifth step 1610, parameter generator 1106 sets the operational parameters (gather parameters associated with statically available data) appropriate for the particular data source, and method 1600 ends.

If, in step 1606, parameter generator 1106 determines that no predetermined context exists for the new data source, then method 1600 proceeds to a sixth step 1612, where source analyzer 1108 determines whether there are any dynamic parameters associated with the new source. If so, then in a seventh step 1614, parameter generator 1106 sets all dynamic parameters associated with the new source, and then method 1600 proceeds to fifth step 1610.

If, in step 1608, parameter generator 1106 determines that the predetermined context includes dynamic parameters, then in an eighth step 1616, parameter generator sets all dynamic parameters included in the predetermined context. Then method 1600 proceeds to fifth step 1610.

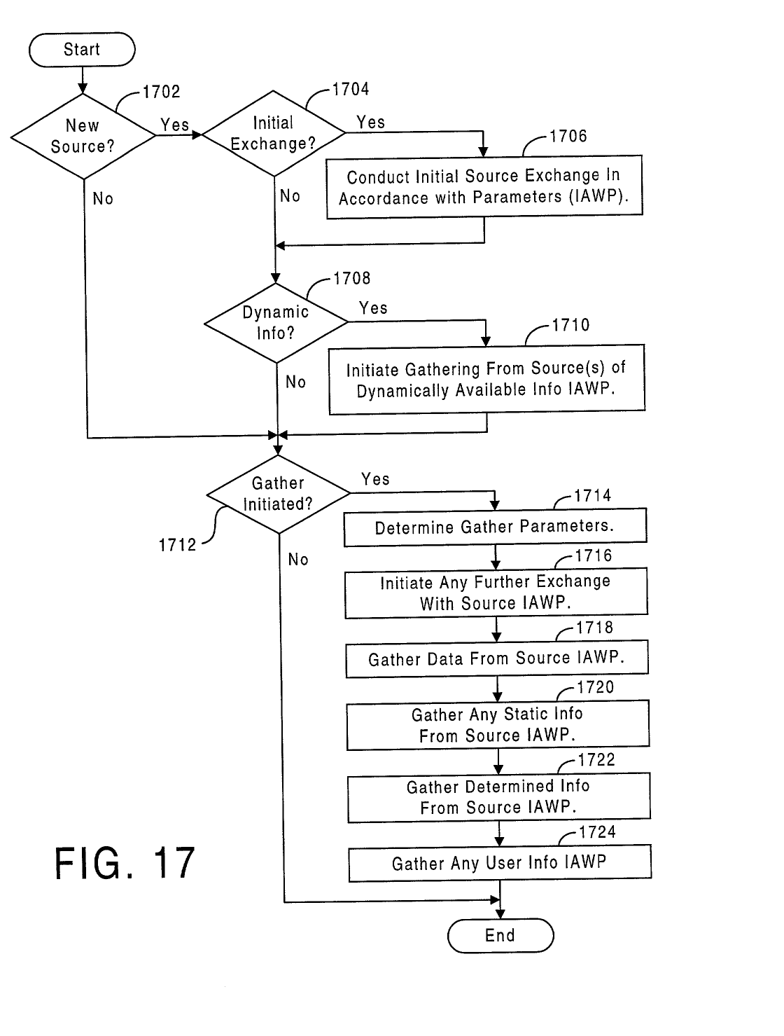

FIG. 17 is a flow chart summarizing an example method of gathering data in accordance with gather parameters. In step 1702, gather system 1014 determines whether there is a new potential data source. If there is a new potential data source, then in step 1704, gather controller 1102 determines from the previously set gather criteria whether an initial exchange with the new source is required. In some cases, an initial exchange with a source is required for conducting a security/purchase transaction operation, analyzing the source to determine information availability, to establish gather criteria, etc. (e.g. see above). If an initial exchange is required, then in step 1706 gather controller 1102 conducts the initial source exchange in accordance with previously determined dynamic gather parameters (criteria), and then method 1700 proceeds to a 1708. If an initial exchange is not required, then method 1700 proceeds directly from step 1704 to step 1708. In step 1708, gather controller 1102 determines from the gather parameters whether the new source includes dynamically available data. If so, then in step 1710, data gatherer 1112 begins to gather the dynamically available data from the source, in accordance with the set parameters, and then method 1700 proceeds to step 1712. However, if the source includes no dynamically available data, then method 1700 proceeds directly from step 1708 to step 1712. Method 1700 also proceeds directly to step 1712 if, in first step 1702, gather system determines that there is a new data source.

In step 1712, gather controller 1102 determines whether a gather operation has been initiated. If not, method 1700 ends. If, however, a gather operation is initiated, then in step 1714, parameter generator determines the gather parameters for the initiated gather operation. Next, in step 1716, gather controller initiates any further exchange with the source, and then, in step 1718, data gatherer 1112 gathers data from the source in accordance with the determined parameters. Next, in step 1720, data gatherer 1112 gathers any static info from the source according to the determined parameters, and in step 1722 gathers any determined information from the source according to the gather parameters. Finally, in step 1724, data gatherer 1112 gathers any user information indicated by the gather parameters, after which method 1700 ends.

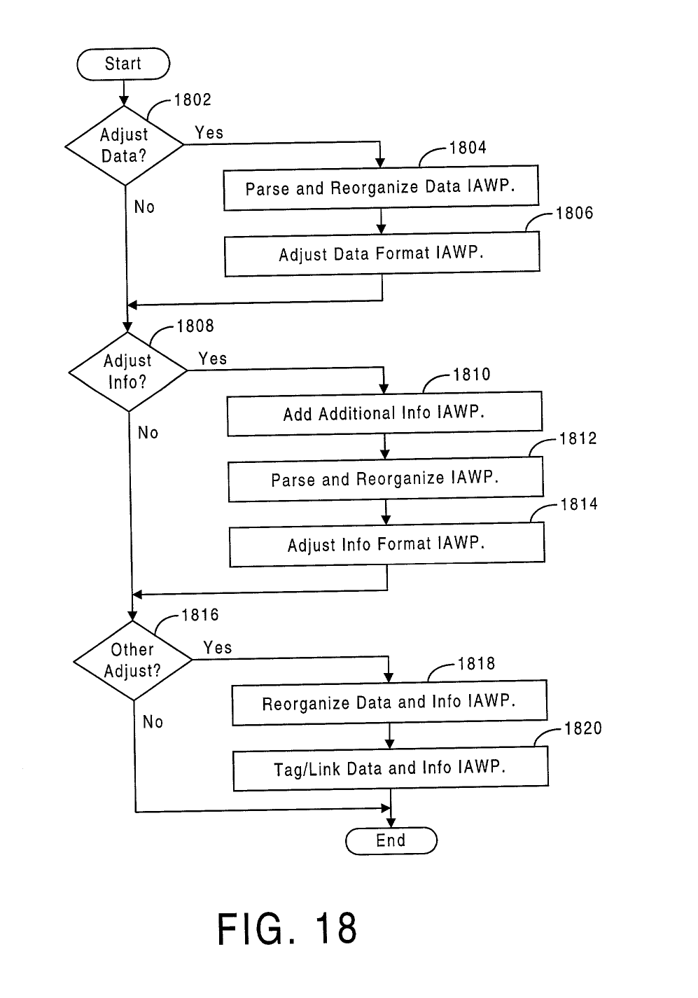

FIG. 18 is a flow chart summarizing an example method of manipulating and/or augmenting gathered data according to predetermined gather criteria. In step 1802, gather controller determines from the gather parameters whether any adjustment of the gathered data is required. If so, then in step 1804 data/information manipulator 1124 parses and reorganizes the gathered data as/if required by the predetermined parameters. Next in step 1806, manipulator 1124 reformats the gathered data as/if required by the predetermined parameters.

Method 1800 then proceeds to step 1808, where gather controller determines from the gather parameters whether the gathered information requires adjustment. If so, then in step 1810, manipulator 1124 augments the gathered information as/if required by the predetermined parameters. Next, in step 1812, manipulator 1124 parses and reorganizes the gathered information as/if required by the predetermined parameters. Next in step 1814, manipulator 1124 reformats the gathered information as/if required by the predetermined parameters.

Method 1800 then proceeds to step 1816, where gather controller 1102 determines from the gather parameters whether any further adjustments to the gathered data are required. If so, then in a ninth step 1818 manipulator 1124 reorganizes the gathered data (including the gathered information) in accordance with the predetermined parameters. Next, in step 1820, manipulator 1124 tags and/or links the gathered data and information in accordance with the gather parameters. Then, method 1800 ends.

If, in step 1802, gather controller 1102 determines that no data adjustments are necessary, then method 1800 proceeds to step 1808. Similarly, if in step 1808, gather controller 1102 determines that no information adjustments are necessary, then method 1800 proceeds to step 1816. If, in step 1816, gather controller 1102 determines that no further adjustments are required to the data or information, then method 1800 ends.

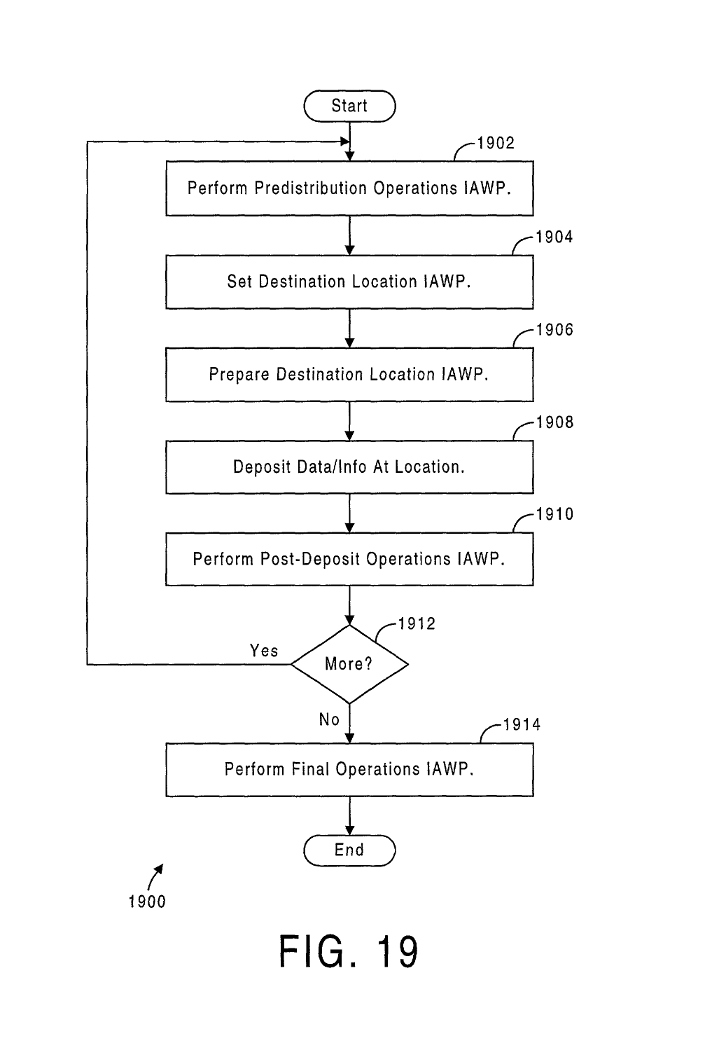

FIG. 19 is a flow chart summarizing an example method 1900 for distributing gathered data. In step 1902, manipulator 1124 performs any predistribution operations (or “processing”) on the gathered data according to the gather parameters. Next, in step 1904, gather controller sets the destination location according to the gather criteria (parameters). Then, in step 1906, gather controller 1102 prepares the destination location, and in step 1908 data distributor 1114 and information distributor 1118 deposit the gathered data to the prepared destination, in accordance with the gather criteria. Next, in step 1910, manipulator 1124 performs any post deposit operations required by the gather parameters. Then, in a sixth step 1912, gather controller determines whether any further distributions of gathered data are required by the gather parameters. If so, method 1900 returns to step 1902. Otherwise, method 1900 proceeds to step 1914, where gather controller 1102 performs any final operations required by the gather criteria, and then method 1900 ends.

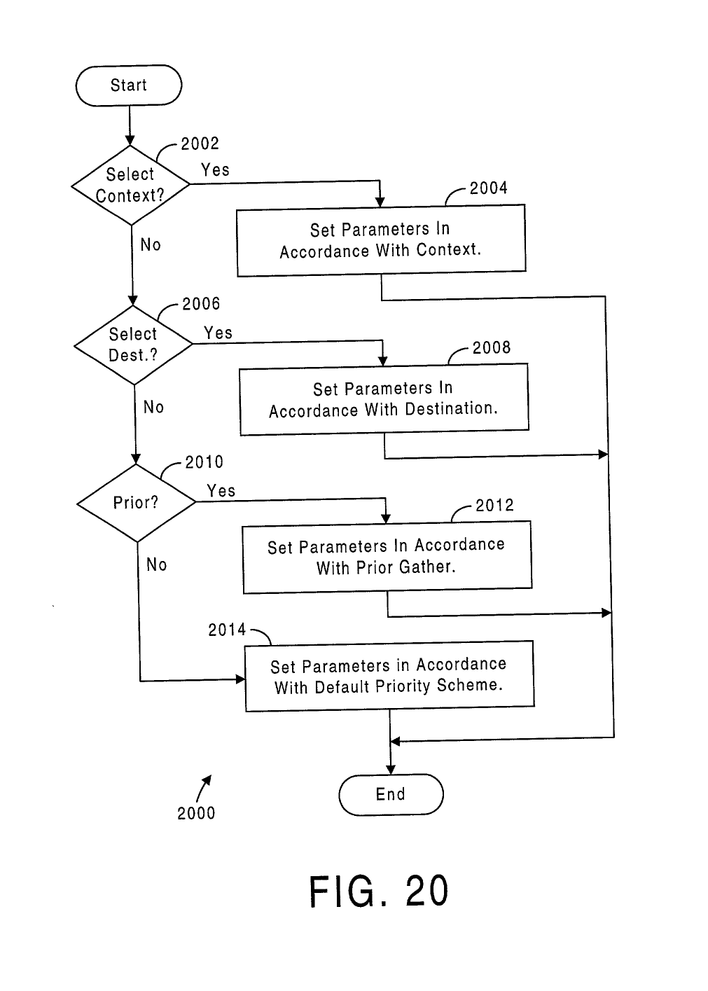

FIG. 20 is a flow chart summarizing an example method 2000 of determining gather criteria. In step 2002, parameter generator 1106 determines whether a predetermined context is selected. If so, then in step 2004, parameter generator 1106 sets the gather parameters according the selected context, then method 2000 ends. Otherwise, method 2000 proceeds to step 2006 where parameter generator 1106 determines whether a destination has been selected. If so, then in step 2008, parameter generator 1106 sets the gather parameters according to a predetermined parameter set associated with the selected destination, and method 2000 ends. Otherwise, method 2000 proceeds to step 2010 where parameter generator 1106 determines whether the parameters from the prior gather operation should be used. If so, then in step 2012 parameter generator 1106 sets the gather parameters as in the previous gather operation, and method 2000 ends. Otherwise, method 2000 proceeds to step 2014, where parameter generator 1106 sets the gather parameters according to default values.

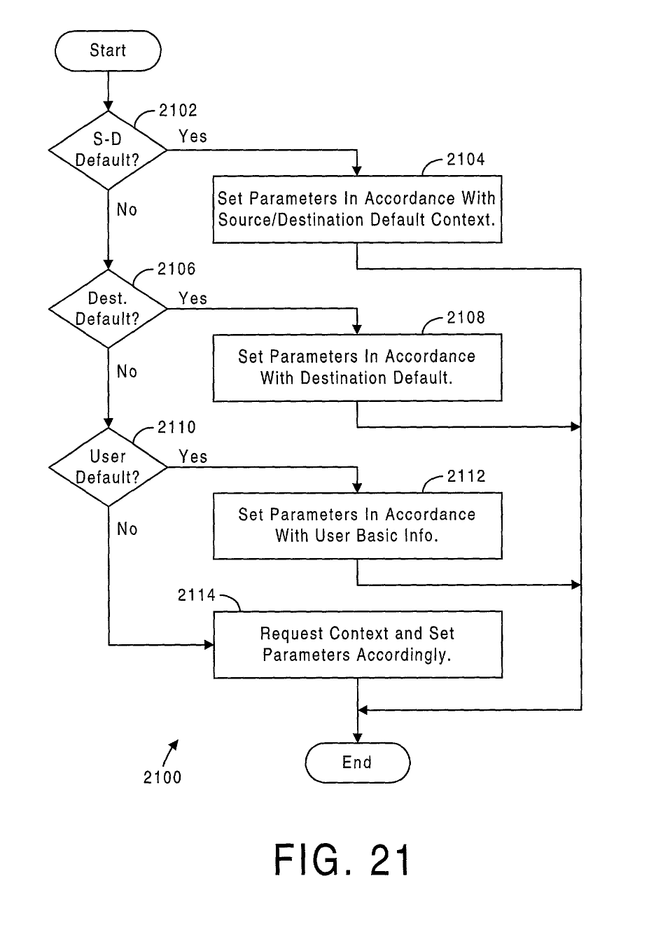

FIG. 21 is a flow chart summarizing an example method 2100 of setting gather parameters according to a context selection hierarchy. In step 2102, parameter generator 1106 determines whether there exists a default parameter set for the selected source and destination. If so, then in step 2104, parameter generator 1106 sets the source/destination default context. Otherwise, method 2100 proceeds to step 2106 where parameter generator 1106 determines whether a default parameter set exist for a selected destination. If so, then in step 2108 parameter generator 1106 sets the destination default context. Otherwise, in step 2110, parameter generator 1106 determines whether there exists a default parameter set for the particular user. If so, then in step 2112, parameter generator sets the user default context for the current user. Otherwise, method 2100 proceeds to step 2114, where parameter generator requests a context from the user, and sets the gather parameters accordingly. Then method 2100 ends.

The description of example particular embodiments of the present invention is now complete. Additional benefits of the present invention will become available as limitations of existing technical standards are overcome. For example, the current ability to recognize the substantive content of text (e.g., author's name, publisher's name, dates, addresses, etc.) is somewhat limited, therefore limiting the ability of a gather system to effectively, gather, process, and distribute particular data. Solutions to this problem include, but are not limited to the following. One possible solution is for sources to provide information regarding the format of the source data (e.g., content location, content format, content type, etc.). This information can be fetched from the source prior to initiating a gather operation, so that subsequently gathered data can be recognized. Another solution would be to develop a data exchange protocol that supports the features of a gather system. Yet another solution would be for sources to embed tags, flags, and or other indicia of data content/format into the data, whereby a gather system could identify the data as it is gathered.

Many of the described features may be substituted, altered or omitted without departing from the scope of the invention. It is impossible to create an exhaustive list of such modifications, since gathering and other aspects are so new and are applicable to so many applications, scenarios, interfaces, implementations, etc. (e.g. using applets alone or with other programming, supporting workgroups, in communication vs. singular or intermittent operations, using different hardware and/or supporting PCs, PIMs, smart appliances or other devices, data manipulations, security, e-commerce, tracking, scheduling, etc.). Also, the nature of a particular context relates to user goals, scenarios, and not just a current command, as with existing capabilities, among other new aspects. These and other deviations from the particular embodiments shown will be apparent to those skilled in the art, particularly in view of the foregoing disclosure.

I claim:

1. A data gathering method comprising:
determining criteria for transferring a selected data portion from a source to at least one destination;
interfacing with said source;
gathering said selected data portion and other data according to said criteria; and
distributing said data and said other data to at least one destination according to said criteria.

2. A method according to claim 1, wherein said criteria depends on a program type associated with said source of selected data portion.

3. A method according to claim 1, wherein said criteria depends on a program type associated with said at least one destination.

4. A method according to claim 1, wherein said criteria depends on a context in which said data gathering method is invoked.

5. A method according to claim 4, wherein said criteria further depends on a subcontext in which said data gathering method is invoked.

6. A method according to claim 4, wherein said context is selectable by a user from a plurality of predefined contexts.

7. A method according to claim 6, further comprising:
defining a new context as a set of transfer criteria; and
storing said new context for subsequent selection and use.

8. A method according to claim 6, wherein said context remains selected for subsequent gathering operations.

9. A method according to claim 4, wherein said context is determined according to a rule-based algorithm depending on currently invoked user applications.

10. A method according to claim 1, wherein said criteria are determined with the use of an artificial intelligence program.

11. A method according to claim 1, wherein said criteria include a set of default values.

12. A method according to claim 1, wherein said criteria depends on a layout of said source.

13. A method according to claim 1, wherein said criteria depends on a layout of said destination.

14. A method according to claim 1, wherein said step of interfacing with said source includes negotiating a security routine.

15. A method according to claim 1, wherein said step of interfacing with said source includes a tracking operation.

16. A method according to claim 1, wherein said step of interfacing with said source includes negotiating a commercial transaction.

17. A method according to claim 1, wherein said step of gathering said other data includes monitoring intermittently available data.

18. A method according to claim 1, wherein said other data includes discrete selected data blocks.

19. A method according to claim 1, wherein said step of gathering said other data includes using an index to locate said other data.

20. A method according to claim 1, further comprising:
analyzing said gathered data to determine a new set of criteria;
gathering new data according to said new set of criteria; and
distributing said new gathered data to at least one new destination.

21. A method according to claim 20, wherein said step of analyzing said gathered data to determine a new set of criteria includes interaction with a user.

22. A method according to claim 20, wherein said step of analyzing said gathered data to determine a new set of criteria excludes interaction with a user.

23. A method according to claim 20, wherein:
said gathered data includes a form; and
said gathered new data includes data necessary to complete said form.

24. A method according to claim 1, wherein said selected data is multimedia data.

25. A method according to claim 1, wherein said gathered data is multimedia data.

26. A method according to claim 25, wherein said gathered data includes multimedia data of different types.

27. A method according to claim 26, wherein each type of multimedia data is handled differently according to type.

28. A method according to claim 1, wherein said step of distributing said gathered data includes distributing to a plurality of destinations.

29. A method according to claim 28, wherein said step of distributing said gathered data includes distributing a copy of at least a portion of said gathered data in each of at least two destinations.

30. A method according to claim 28, wherein said step of distributing said gathered data includes distributing a portion of said gathered data to one destination, and distributing another portion of said gathered data to another destination.

31. A method according to claim 28, wherein said step of distributing said gathered data includes creating links between disparately distributed data portions.

32. A method according to claim 28, wherein said step of distributing said gathered data includes creating an index to said distributed data.

33. A method according to claim 1, wherein said gathered data is distributed within a multimedia document.

34. A method according to claim 1, wherein at least a portion of said gathered data is distributed to a remote destination.

35. A method according to claim 1, further comprising performing a processing operation on at least a portion of said gathered data.

36. A method according to claim 35, wherein said processing operation includes a pre-gather operation.

37. A method according to claim 36, wherein said pre-gather operation includes a security operation.

38. A method according to claim 35, wherein said processing operation includes a during-gather operation.

39. A method according to claim 38, wherein said during-gather operation includes an augmentation operation.

40. A method according to claim 35, wherein said processing operation includes a post-gather operation.

41. A method according to claim 40, wherein said post-gather operation includes a purchase transaction.

42. A method according to claim 35, wherein said processing operation includes a pre-distribution operation.

43. A method according to claim 42, wherein said pre-distribution operation includes an analyze destination operation.

44. A method according to claim 35, wherein said processing operation includes a during-distribution operation.

45. A method according to claim 44, wherein said during-distribution operation includes a linking operation.

46. A method according to claim 35, wherein said processing operation includes a post-distribution operation.

47. A method according to claim 46, wherein said post-distribution operation includes a tracking operation.

48. A method according to claim 35, wherein at least a portion of said distributed data includes a result of said processing operation.

49. A method according to claim 48, wherein said result includes summarized data.

50. A method according to claim 1, wherein said data gathering method is performed within the operation of an application program.

51. A method according to claim 1, wherein said data gathering method is performed in conjunction with an application program.

52. A method according to claim 51, wherein said application program is a search engine.

53. A method according to claim 1, further comprising retrieving information from said source relating to the structure of data available from said source.

54. A method according to claim 1, wherein said step of gathering said data includes gathering identifying indicia embedded in said data indicative of the structure of said data.

55. A method according to claim 1, wherein said data is gathered according to a protocol whereby data portions are identified according to content type.

56. A method according to claim 1, wherein said criteria identifies alternate sources for said other data.

57. A computer-readable media having code embodied therein for causing an electronic system to perform the steps of claim 1.

58. A data-gathering method, comprising:
identifying source data to be gathered;
automatically gathering at least a portion of the source data; and
automatically distributing the gathered data to at least one selectable destination.

59. The method of claim 58, wherein the identifying source data information includes determining highlighted source data.

60. The method of claim 58, further comprising, before the automatically gathering, receiving an indication to gather the data.

61. The method of claim 60, wherein the indication includes a command to gather.

62. The method of claim 58, further comprising gathering other data related to the source data, and wherein the gathered data includes the at least a portion of the source data and the other data.

63. The method of claim 58, wherein the at least one selectable destination is selectable by the user.

64. The method of claim 58, wherein the at least one selectable destination is determined based on the gathered data.

65. The method of claim 58, wherein the at least one selectable destination includes a document managed by an application program.

66. The method of claim 65, wherein the at least one selectable destination includes a predetermined section of the document.

67. The method of claim 65, wherein the document includes one of a word processing document, a spreadsheet, an email or a web page.

68. The method of claim 65, wherein the application program includes one of a word processing program, a spreadsheet program, an email program, and a web server program.

69. The method of claim 58, wherein the automatically distributing includes automatically distributing a first portion of the gathered data to a first destination and automatically distributing a second portion of the gathered data to a second destination.

70. The method of claim 58, further comprising manipulating at least a portion of the gathered data.

71. The method of claim 70, wherein the manipulating includes formatting at least a portion of the gathered data.

72. A gathered data set produced according to the method of claim 1.

73. A data gathering method comprising:
determining criteria for transferring a selected data portion from a source to at least one destination;
gathering said selected data portion from said source;
manipulating said data portion according to said criteria; and
distributing said manipulated data portion to at least one destination according to said criteria.

74. A computer-readable media having code embodied therein for causing an electronic system to perform the steps of claim 73.

75. A gathered data set produced according to the method of claim 73.

76. A data gathering method comprising:
determining criteria for transferring a selected data portion from a source to a plurality of destinations;
gathering said selected data portion from said source; and
distributing copies of said selected data portion to each of said plurality of destinations according to said criteria.

77. A computer-readable media having code embodied therein for causing an electronic system to perform the steps of claim 76.

78. A gathered data set produced according to the method of claim 76.

79. A data gathering system comprising:
a memory device for storing data and code, said code including a gather engine responsive to an initiate signal, and operative to determine criteria for transferring a selected data portion from a source to at least one destination, gathering said selected data portion and other data according to said criteria, and distributing said data and said other data to at least one destination according to said criteria; and
a processing unit for executing said code.

80. A data gathering system according to claim 79, wherein said gather engine is further operative to determine said gather criteria depending on a program type associated with said source of said selected data portion.

81. A data gathering system according to claim 79, wherein said gather engine is further operative to determine said gather criteria depending on a program type associated with said destination.

82. A data gathering system according to claim 79, wherein said gather engine is further operative to determine said gather criteria based on a predetermined context.

83. A data gathering system according to claim 79, wherein said gather engine includes an artificial intelligence based parameter generator operative to determine said gather criteria based on past use of said data gathering system.

84. A data gathering system according to claim 79, further comprising a default gather criteria set.

85. A data gathering system according to claim 79, further comprising:
a source analyzer module responsive to the selection of a potential data source and operative to analyze said potential data source and to produce a result of said analysis; and
a parameter generator operative to determine said gather criteria based at least in part on said result of said analysis.

86. A data gathering system according to claim 79, further comprising:
a destination analyzer module responsive to the selection of a potential destination and operative to analyze said potential destination and to produce a result of said analysis; and
a parameter generator operative to determine said gather criteria based at least in part on said result of said analysis.

87. A data gathering system according to claim 79, wherein said gather engine is further operative to negotiate a security routine with data source.

88. A data gathering system according to claim 79, wherein said gather engine is further operative to track data transfers.

89. A data gathering system according to claim 79, wherein said gather engine is further operative to negotiate a commercial transaction.

90. A data gathering system according to claim 79, wherein said gather engine responsive to said gather criteria is operative to gather intermittently available data from said source.

91. A data gathering system according to claim 79, wherein said gather engine responsive to said gathered data is further operative to generate a new set of criteria, gather new data according to said new set of criteria, and distribute said new gathered data to at least one new destination.

92. A data gathering system according to claim 79, wherein said gather engine responsive to said gather criteria is further operative to gather multimedia data of a variety of tyes, handling each type of mutimedia data differently according to type.

93. A data gathering system according to claim 79, wherein said gather engine includes a data distributor responsive to said gather criteria and operative to distribute said gathered data to a plurality of destinations.

94. A data gathering system according to claim 93, wherein said data distributor is further operative to distribute a copy of at least a portion of said gathered data to each of at least two destinations.

95. A data gathering system according to claim 93, wherein said dat distributor is further operative to distribute a portion of said gathered data to one destination, and another portion of said data to another destination.

96. A data gathering system according to claim 93, wherein said data distributor is further operative to create links between disparately distributed data portions.

97. A data gathering system according to claim 93, wherein said data distributor is further operative to create an index to said distributed data portions.

98. A data gathering method according to claim 79, wherein said gather engine responsive to said gather criteria is further operative to perform a processing operation on at least a portion of said gathered data.

99. A data gathering system according to claim 79, wherein
said system includes at least one other program; and
said gather engine is included within said other program.

100. A data gathering system according to claim 79, wherein
said system includes at least one other program; and
said gather engine is interactive with said other program.

101. A data gathering system according to claim 100, wherein said other program includes a search engine.

102. A data gathering system according to claim 79, wherein said gather engine includes a source analyzer responsive to said gather criteria and operative to retrieve information from a source relating to the structure of data available from said source.

103. A data gathering system according to claim 79, wherein said gather engine further includes a gather controller operative to recognize identifying indicia embedded in said gathered data.

104. A data gathering system according to claim 79, wherein said gather engine further includes a data gatherer responsive to said gather criteria and operative to gather data from said source according to a protocol whereby data portions are identified according to content type.

105. A data gathering system according to claim 79, wherein said gather engine responsive to said gather criteria is further operative to gather said other data from one or more alternate sources if said other data is unavailable from said source.

106. A data gathering system comprising:
means for determining criteria for transferring a selected data portion from a source to at least one destination;
means for interfacing with said source;
means for gathering said selected data portion and other data according to said criteria; and
means for distributing said data and said other data to at least one destination according to said criteria.

107. A data gathering system comprising:
means for determining criteria for transferring a selected data portion from a source to at least one destination;
means for gathering said selected data portion from said source;
menas for manipulating said data portion according to said criteria; and
means for distributing said manipulated data portion to at least one destination according to said criteria.

108. A data gathering system comprising:
means for determining criteria for transferring a selected data portion from a source to a plurality of destinations;
means for gathering said selected data portion from said source; and
means for distributing copies of said selected data portion to each of said plurality of destinations according to said criteria.
